(19) United States
(12) Patent Application Publication
(10) Pub. No.: US 2018/0077650 A1
(43) Pub. Date: Mar. 15, 2018

(54) WIRELESS COMMUNICATION APPARATUS, WIRELESS COMMUNICATION SYSTEM, AND COMMUNICATION CONTROL METHOD

(71) Applicant: FUJITSU LIMITED, Kawasaki-Shi (JP)

(72) Inventor: Shiho NAKAHARA, Nerima (JP)

(73) Assignee: FUJITSU LIMITED, Kawasaki-Shi (JP)

(21) Appl. No.: 15/684,667

(22) Filed: Aug. 23, 2017

(30) Foreign Application Priority Data
Sep. 14, 2016 (JP) 2016-179088

(51) Int. Cl. H04W 52/02; H04W 56/00; H04W 72/12

(52) U.S. Cl. CPC H04W 52/0258; H04W 52/0229; H04W 84/18; H04W 72/12; H04W 56/0015

(57) ABSTRACT

A wireless communication apparatus configured to communicate with another wireless communication apparatus in a wireless network in accordance with a synchronized periods, includes a wireless communication device configured to send and receive a wireless signal with the other wireless communication apparatus, a memory, and a processor coupled to the memory and configured to acquire an index value related to a traffic amount within the wireless network, and determine, based on the index value, a first time length of a certain period during which the wireless communication device is in an ON state in a single period of the synchronized periods.

### CROSS-REFERENCE TO RELATED APPLICATION

This application is based upon and claims the benefit of priority of the prior Japanese Patent Application No. 2016-179088, filed on Sep. 14, 2016, the entire contents of which are incorporated herein by reference.

### FIELD

The embodiments discussed herein are related to a wireless communication apparatus, a wireless communication system, and a communication control method.

### BACKGROUND

A sensor network includes a gateway (GW) and a plurality of sensor nodes. The sensor nodes are distributed and installed in the sensor network. In the sensor network, the results of monitoring by the sensor nodes are collected by the GW and sent to a higher-level network. The sensor nodes execute wireless communication according to IEEE 802.15.4 or the like and send the monitoring results to the GW.

The sensor network may be built as an ad-hoc network. In the ad-hoc network, each of the nodes also operates as a relay node that relays data received from another node.

In the sensor network, sensor nodes that are operated by batteries may be used for convenience or for the purpose of ensuring power supplies. If the sensor nodes are operated by the batteries, communication functions of the sensor nodes are turned off during the time when communication is not executed, and the turning off of the functions save power. The power saving results in a reduction in consumed power. Hereinafter, a time period during which a communication function of a sensor node is turned on and the sensor node is able to send and receive data is referred to active period. In addition, a time period during which a communication function of a sensor node is turned off is referred to as sleep period.

If the sensor nodes serve as the relay nodes, each of the sensor nodes relays data received from another sensor node. Thus, even during the time when a sensor node does not execute communication related to the sensor node, the sensor node is not able to switch an active period to a sleep period.

As a method of saving power of the sensor nodes, there is a method of synchronizing periodical switching between active periods and sleep periods of all the nodes within the network.

Examples of related art are Japanese Laid-open Patent Publication Nos. 2011-176888, 2011-120151, 2011-91684, 2011-10018, and 2009-290581.

### SUMMARY

According to an aspect of the invention, a wireless communication apparatus configured to communicate with another wireless communication apparatus in a wireless network in accordance with a synchronized periods, includes a wireless communication device configured to send and receive a wireless signal with the other wireless communication apparatus, a memory, and a processor coupled to the memory and configured to acquire an index value related to a traffic amount within the wireless network, and determine, based on the index value, a first time length of a certain period during which the wireless communication device is in an ON state in a single period of the periods.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a sensor network system according to a first embodiment;

FIG. 2 is a diagram illustrating an example of the configuration of each of superframes;

FIG. 3 is a diagram illustrating an example of the format of a data frame to be used by each of nodes to notify the amount of unsent data stored in a sending queue of the node;

FIG. 4 is a diagram illustrating an example of the format of a data frame having relay history records added thereto;

FIG. 5 is a diagram illustrating an example of a hardware configuration of the GW;

FIG. 6 is a diagram illustrating an example of a functional configuration of the GW;

FIG. 7 is a diagram illustrating an example of a hardware configuration of each of the sensor nodes;

FIG. 8 is a diagram illustrating an example of a functional configuration of each of the sensor nodes;

FIG. 9 is a diagram illustrating an example of schedule information stored in a schedule information storage section;

FIG. 10 is a diagram illustrating an example of an adjacent node information table stored in an adjacent node information storage section;

FIG. 11 is an example of a flowchart of a process to be executed by a schedule controller of the GW;

FIG. 12 is an example of a flowchart of a process to be executed by the schedule controller of the GW in a sleep period of the GW;

FIG. 13 is an example of a flowchart of a process to be executed by a mode controller of each of the nodes;

FIG. 14 is a diagram illustrating an example of the notification of a change in an active time length to the nodes;

FIG. 15 is a diagram illustrating a configuration of the sensor network system in a simulation according to the first embodiment;

FIG. 16 is a flowchart of a process to be executed by the GW in a sleep period of the GW in the simulation according to the first embodiment;

FIG. 17 is a graph illustrating monitoring results obtained during active periods of the GW in the simulation according to the first embodiment;

FIG. 18 is a diagram illustrating an example of the configuration of each of superframes according to a second embodiment;

FIG. 19 is a diagram illustrating an example of an adjacent node information table according to the second embodiment;

FIG. 20 is an example of a flowchart of a process to be executed by a mode controller of each of the nodes according to the second embodiment;

FIG. 21 is an example of a flowchart of a process to be executed by a sending processing section of each of the nodes according to the second embodiment; and

FIG. 22 is an example of a flowchart of a process, to be executed by a sending processing section of each of the nodes according to the second embodiment, of determining the timing of sending.

### DESCRIPTION OF EMBODIMENTS

If an active period is too short, a packet may not be sent by a relay node in the active period and may be sent in the next active period and significantly delayed. If the active period is too long, an effect of saving power is reduced.

The present disclosure aims to provide a wireless communication apparatus, a wireless communication system, and a communication control method that adjust, based on a traffic amount, power to be consumed by the wireless communication apparatus.

Hereinafter, embodiments are described with reference to the accompanying drawings. Configurations described in the embodiments are examples, and techniques disclosed herein are not limited to the configurations described in the embodiments.

### First Embodiment

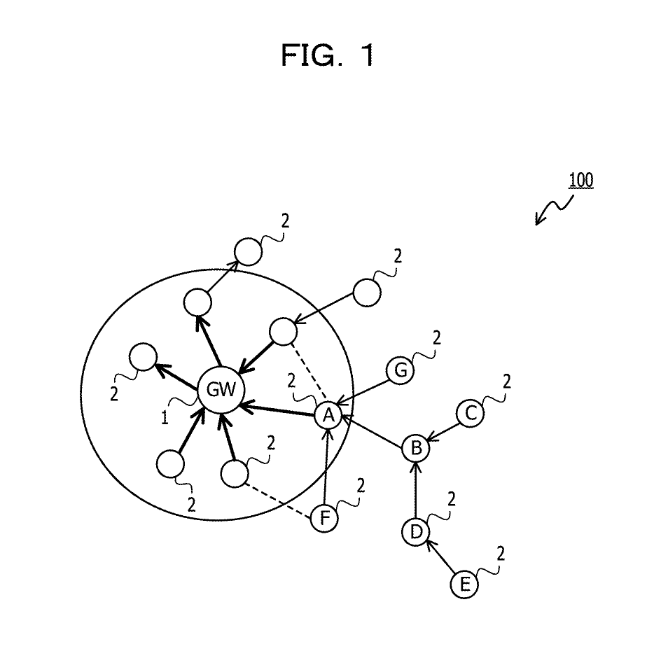

FIG. 1 is a diagram illustrating an example of the configuration of a sensor network system according to a first embodiment. The sensor network system 100 includes a GW 1 and a plurality of sensor nodes 2. Each of the sensor nodes 2 monitors a target during a predetermined period or in response to the occurrence of a predetermined event and sends monitoring results to the GW 1. The GW 1 sends the monitoring results received from the sensor nodes 2 to a higher-level network (not illustrated). Each of the sensor nodes 2 includes a sensor for measuring any or a combination of a temperature, a voltage, an illuminance intensity, acceleration, and the like. Hereinafter, the sensor nodes 2 are merely referred to as nodes 2 in some cases.

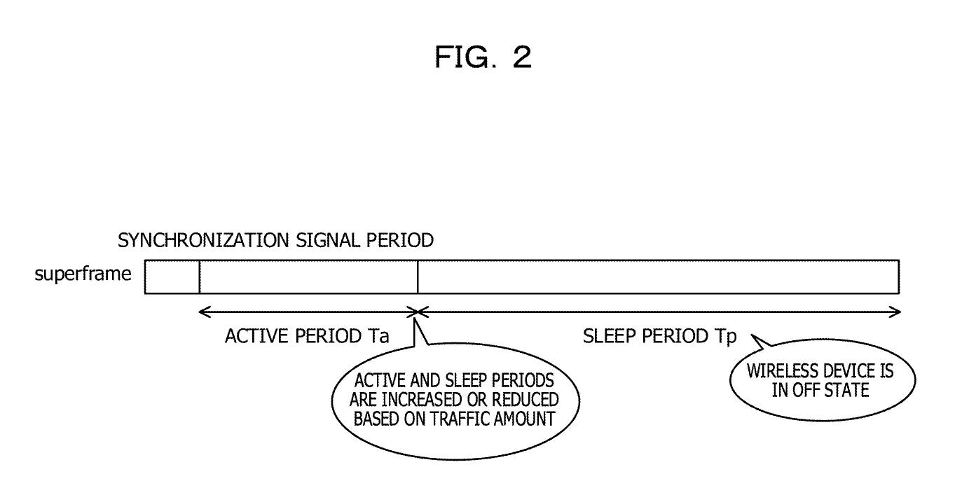

FIG. 2 is a diagram illustrating an example of the configuration of each of superframes. The superframes are time periods for communication in the sensor network system 100 and are obtained by dividing time into predetermined lengths. All the nodes 2 and the GW 1 that are included in the sensor network system 100 synchronize a superframe period based on a synchronization signal sent by the GW 1. Each of the superframe periods may be arbitrarily set by an administrator of the sensor network system 100 to, for example, 500 milliseconds.

Each of the superframes includes three time periods, a synchronization signal period, an active period, and a sleep period. Each of the synchronization signal periods is a time period in which a synchronization signal to synchronize a superframe is sent and received. The synchronization signal is also referred to as beacon signal. In the sensor network system 100, the nodes 2 synchronize a superframe based on the synchronization signal from the GW 1. The synchronization signal periods are fixed. In the present specification, for each of the “periods”, the start time of the period and either or both of the end time of the period and the length of the period are defined.

The active periods are periods during which the sensor nodes 2 execute communication. During the active periods, the sensor nodes 2 execute the communication using Carrier Sense Multiple Access/Collision Avoidance (CSMA/CA). The sleep periods are periods during which the sensor nodes 2 turn off communication functions of the sensor nodes 2. Hereinafter, the lengths of the active periods are referred to as active time lengths Ta, and the lengths of the sleep periods are referred to as sleep time lengths Tp.

In the first embodiment, the configurations of the superframes are commonly used by the GW 1 and all the nodes 2 in the sensor network system 100. In the first embodiment, the active time lengths Ta are dynamically changed based on a traffic amount. The dynamical changes adjust, based on the traffic amount, power to be consumed by the sensor nodes 2 and the GW 1. In the first embodiment, the GW 1 acquires an index value related to the traffic amount and determines an active time length Ta based on the acquired index value. The active time length Ta is notified to the sensor nodes 2 by the synchronization signal. The sensor nodes 2 switch active periods to sleep periods in accordance with the notified active time length Ta.

Since a synchronization signal period is fixed in each of the superframes, the total of an active time length Ta and a sleep time length Tp is a fixed value in each of the superframes. The order of an active period and a sleep period in each of the superframes is not limited to that illustrated in FIG. 2. For example, a sleep period may be after a synchronization signal period, and an active period may be after the sleep period in each of the superframes. In addition, a plurality of active periods and a plurality of sleep periods may be in each of the superframes. For example, an active period 1, a sleep period, and an active period 2 may be after a synchronization signal period in this order in each of the superframes.

If the order of active and sleep periods is not fixed in each of the superframes, two or more of the length of the active period of the superframe, the start time of the active period, and the end time of the active period are determined. Information that indicates an active period of a superframe, a sleep period of the superframe, the lengths of the active and sleep periods, the start time of the active and sleep periods, the end time of the active and sleep periods, and the like is referred to as schedule information. For each of the superframes, the start time of an active period in the superframe or the start time of a sleep period in the superframe is indicated by a time length from the start time of the superframe.

The first embodiment assumes that the order of active and sleep periods in each of the superframes is set as illustrated in FIG. 2 and is not changed. In each of the superframes, the length of a synchronization signal period is fixed and the start time of the synchronization signal period is fixed to the start time of the superframe. The configuration of each of the superframes is common to all the nodes 2. In addition, the total of an active period and a sleep period in each of the superframes is fixed. Thus, when the length Ta of an active period is determined, the length Tp of a sleep period is determined. Thus, in the first embodiment, it is sufficient if the length Ta (active time length Ta) of an active period is notified as schedule information.

If the order of active and sleep periods is not fixed, two or more of the length of the active period, the start time of the active period, and the end time of the active period are notified as schedule information. If a plurality of active periods is in a superframe, two or more of the length of an active period, the start time of the active period, and the end time of the active period are notified as schedule information for each of the active periods.

Each of the superframes is an example of a “period” in which a “wireless communication apparatus” executes communication. The length Ta of an active period illustrated in FIG. 2 is an example of a “first time length”. The “first time period”, however, may include the total of the length of a synchronization signal period and the length of an active period, for example.

Index Values Related to Traffic Amount

Index values related to the traffic amount are referred to as congestion parameters P. In the first embodiment, as a congestion parameter P or congestion parameters P, any or a combination of (1) a congestion ratio, (2) the rate of executing backtracking, and (3) the rate of increase in the number of relay nodes is used. In the first embodiment, if a predetermined requirement is satisfied by a congestion parameter P, an active time length Ta is increased or reduced.

A first congestion parameter is the congestion ratio. The congestion ratio is the ratio of a time period for sending and receiving data to an active time length Ta.

$$\begin{matrix}The congestion \\ ratio =\end{matrix} \frac{The time period for sending and receiving data}{The active time length Ta} \qquad ( 1 )$$

The first congestion parameter indicates that as the congestion ratio increases, the traffic amount increases. The time period, used to calculate the congestion ratio, for sending and receiving the data is a measured time period for executing a process of sending and receiving the data. If the measured time period for executing the process of sending and receiving the data is used, the congestion ratio is a value in which the amount of traffic in a communication range of a target device during a current superframe is reflected.

The time period, used to calculate the congestion ratio, for sending and receiving the data may be the total of the measured time period for sending and receiving the data and a time period for sending unsent data stored in an adjacent node, for example. In this case, the adjacent node is a node 2 that exists in the communication range of the target device and is able to receive a signal from the target device without another node 2. The time period for sending the unsent data stored in the adjacent node is a time period for sending a packet stored in a sending queue of the adjacent node. If the time period for sending the unsent data stored in the adjacent node is used to calculate the congestion ratio, the congestion ratio is a value in which the amount of traffic in the communication range of the target device during the current superframe and the amount of traffic expected in the communication range of the target device during the next current superframe are reflected.

For example, in the sensor network system 100 illustrated in FIG. 1, a node #A is a relay node, and data sent from nodes #B to #G are concentrated on the node #A. When the amount of the data sent from the nodes #B to #G increases, the data is received by the node #A during most of an active period of the node #A, and the amount of data to be sent to the GW 1 in the active period is reduced. Not all the data received from the nodes #B to #G is sent in the active period of the current superframe, and unsent data is stored in a sending queue of the node #A and sent in an active period of the next superframe or in the active period of the next superframe and later.

In this case, if the active time length Ta is determined using the measured time period for executing the process of sending and receiving the data, the node #A receives data during a long period of the current superframe, the amount of data to be sent by the node #A is small and the amount of traffic from the node #A is underestimated. As a result, the active time length Ta may not be set to a sufficiently long time length. If the active time length Ta is not set to a sufficiently long time length, the node #A may not send all the unsent data stored in the sending queue in the active period of the next superframe.

Thus, the GW 1 causes the node 2 to notify the GW 1 of the amount of the unsent data stored in the sending queue and an adjacent node calculates a time period for sending the unsent data stored in the sending queue. Since the speed of wireless communication of the sensor network system 100 is known, the time period for sending the unsent data may be calculated from the amount of the unsent data.

Since the measured time period for executing the process of sending and receiving the data and the time period (time period for sending the unsent data stored in the adjacent node) for sending the unsent data stored in the sending queue of the adjacent node are used to calculate the congestion ratio, the amount of traffic expected in the next superframe may be reflected in the setting of the active time length Ta.

As the time period, used to calculate the congestion ratio, for sending the unsent data stored in the adjacent node, a total value calculated from the notified amount of the unsent data stored in the sending queue of the adjacent node is used, for example.

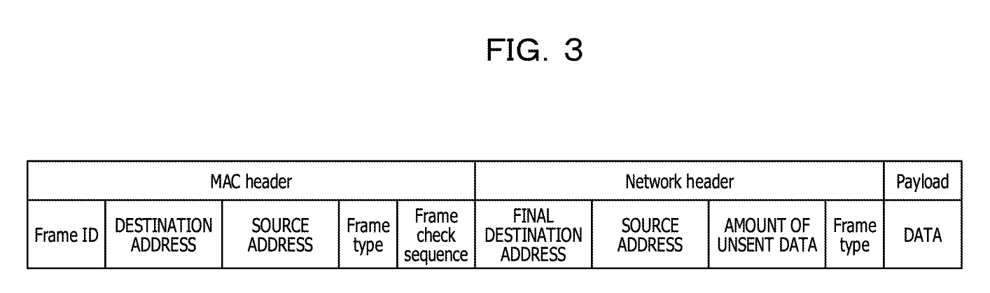

FIG. 3 is an example of the format of a data frame to be used by each of the nodes 2 to notify the amount of unsent data stored in a sending queue of the node 2. The data frame is a data block to be handled in the MAC layer. A packet is a data block to be handled in the network layer. Unless otherwise distinguished, the data frame is also referred to as packet in some cases. A field for storing the amount of the unsent data stored in the sending queue is newly added to a network header, and the amount of the unsent data stored in the sending queue is stored in the added field, as illustrated in FIG. 3, for example. The network header is referenced in a process executed in the network layer. The position of the field for storing the amount of the unsent data stored in the sending queue is not limited to the example illustrated in FIG. 3, and the field for storing the amount of the unsent data stored in the sending queue may be positioned at the end of the packet.

The amount of the unsent data stored in the sending queue is expressed in bytes or the total number of packets, for example. Before a node 2 sends data, the node 2 writes, in a network header of a packet, the amount of the unsent data stored in a sending queue of the node 2. In addition, before a certain node 2 transfers a packet received from another node 2, the certain node 2 writes, in the network header of the packet, the amount of unsent data stored in a sending queue of the certain node 2. A certain node 2 receives a packet from another upstream-side node 2, and the amount of unsent data stored in a sending queue of the upstream-side node 2 is stored in the packet. Thus, before the certain node 2 transfers the packet received from the other upstream-side node 2, the certain node 2 rewrites the amount of unsent data stored in a sending queue of the certain node 2 over the amount of the unsent data stored in the sending queue of the upstream-side node 2.

Instead of the notification of the amount of unsent data stored in a sending queue of a node 2, the node 2 may calculate a time period for sending the unsent data stored in the sending queue and notify the GW 1 of the calculated time period for sending the unsent data. A “time period for sending and receiving data” is an example of a “second time length”. The congestion ratio is an example of the “ratio of the second time length to the first time length”. The amount, notified using the data frame format illustrated in FIG. 3, of unsent data stored in a sending queue, and a time period for sending the unsent data are an example of “information on a time period for sending data held in the other wireless communication apparatus and scheduled to be sent”.

A second congestion parameter is the rate of executing the backtracking. The backtracking is to return a packet to a sender of the packet if a candidate for a transmission or transfer destination to which the packet is to be sent or transferred does not exist. For example, if an obstacle intervenes, a radio propagation environment is degraded, and a link failure occurs, packet transfer is continuously executed using a detour path. Due to the detour path, the amount of traffic in a node 2 located on the downstream side of a communication range of the GW 1 may increase. The ratio of executing the backtracking is used when the amount of traffic that increases in a node 2 located on the downstream side of the communication range of the GW 1 is reflected in the active time length Ta.

Whether or not the backtracking has been executed may be detected by collecting relay history records of a packet. If the rate of executing the backtracking is used as a congestion parameter, the node 2 adds the relay history records to the packet.

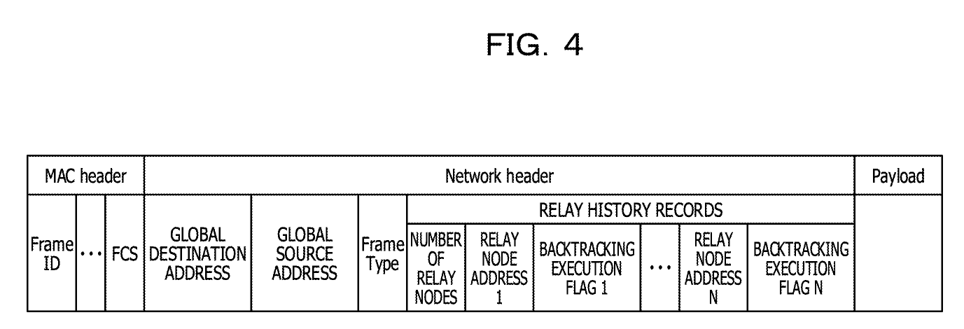

FIG. 4 illustrates an example of the format of a data frame having relay history records added thereto. The relay history records are added to the end of a network header of a packet, for example. A field for storing the relay history records of the packet includes fields for storing the number of relay nodes, relay node addresses, and backtracking execution flags.

In the field for storing the number of relay nodes, the number of relay nodes that have relayed the target packet is stored. In the fields for storing relay node addresses, the addresses of the nodes 2 that have relayed the target packet are stored. The addresses of the nodes 2 that are stored in the fields for storing relay node addresses are Media Access Control (MAC) addresses, for example. If the relay nodes have executed the backtracking, 1 is stored in the fields for the backtracking execution flags. The relay node addresses and the backtracking execution flags are stored for the number of the nodes that have relayed the target packet.

Before a node 2 transfers a packet, the node 2 adds 1 to a value of a field for storing the number of relay nodes to update the value of the field and adds a field for storing an address of the relay node and a field for storing a backtracking execution flag to the end of a field for storing relay history records within the packet. The node 2 writes the address of the node 2 in the added field for storing the address of the relay node and executes the backtracking. Specifically, if the node 2 returns the packet to a transfer source, the node 2 stores 1 in the field for storing the backtracking execution flag. If the backtracking is not executed, the value of the field for storing the backtracking execution flag is 0.

The rate of executing the backtracking is calculated in the following manner using relay history records notified using the data frame format illustrated in FIG. 4.

$$\begin{matrix}The rate of executing the \\ backtracking =\end{matrix} \frac{\begin{matrix}The number of relay nodes that \\ have executing the backtracking\end{matrix}}{\begin{matrix}The number of relay nodes \\ ( the number of hops )\end{matrix}} \qquad ( 2 )$$

The number of relay nodes that have executed the backtracking is the same as the number of fields storing backtracking execution flags indicating 1 in a packet. The number of relay nodes is the same as the value of a field for storing the number of relay nodes in the packet. If multiple packets are received in an active period, the average rate of executing the backtracking on the packets is used as the congestion parameter.

A third congestion parameter is the rate of increase in the number of relay nodes. Paths that extend from the nodes 2 to the GW 1 and in which the numbers of hops are minimal are used as actual paths extending from the nodes 2 to the GW 1 in many cases. Thus, when a detour path is used for a packet, the number of relay nodes that relay the packet tends to increase. Thus, whether or not a detour path is used may be detected by monitoring the rate of increase in the number of relay nodes for each of sending nodes. If the rate of increase in the number of relay nodes is used as the congestion parameter, a node 2 collects relay history records and adds the relay history records to a packet.

The rate of increase in the number of relay nodes is calculated for each of sending nodes in the following manner.

$$\begin{matrix}The rate of increase in \\ the number of relay \\ nodes =\end{matrix} \frac{\begin{matrix}The number of relay nodes - The \\ average number of previous relay nodes\end{matrix}}{\begin{matrix}The average number of previous relay \\ nodes\end{matrix}} \qquad ( 3 )$$

The average number of previous relay nodes is the average number of the relay nodes that have relayed a packet from a target sending node in predetermined time periods or an entire time period, for example. The sending node is identified by a source address within the network header of the packet. The number of relay nodes is the same as the value of the field, included in the packet, for storing the number of relay packets.

As the congestion parameter or congestion parameters, any or a combination of the congestion ratio, the rate of executing the backtracking, and the rate of increase in the number of relay nodes may be used. The congestion ratio, the rate of executing the backtracking, and the rate of increase in the number of relay nodes may be used as the congestion parameters and are examples of an “index value related to a traffic amount in a wireless network”.

Configurations of Devices

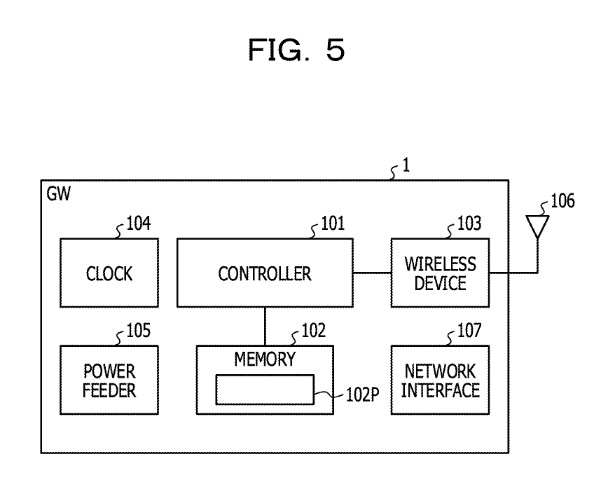

FIG. 5 is a diagram illustrating an example of a hardware configuration of the GW 1. The GW 1 is a dedicated device, for example. The GW 1 includes, as hardware constituent elements, a controller 101, a memory 102, a wireless device 103, a clock 104, a power feeder 105, an antenna 106, and a network interface 107.

The memory 102 is a semiconductor memory such as a random access memory (RAM), for example. The memory 102 may include a read only memory (ROM). The memory 102 stores various programs and data to be used by the controller 101 to execute the programs. The memory 102 stores a wireless communication program and a scheduling program 102P. The wireless communication program is a program for executing a process related to wireless communication of the GW 1. The scheduling program 102P is a program for determining the active time length Ta based on a traffic amount. The scheduling program 102P may be one of modules of the wireless communication program or may be different from the wireless communication program.

The controller 101 includes a processor and a memory, for example. The memory included in the controller 101 is used as a work area of the processor. The memory included in the controller 101 is, for example, a RAM whose access speed is higher than the memory 102. The processor loads, in the memory included in the controller 101, an OS held in the memory 102 and various application programs held in the memory 102, executes the OS and the application programs, and executes various processes. The number of processors included in the controller 101 may not be one and may be two or more. The controller 101 is an example of a “controller”.

The wireless device 103 includes a circuit for modulating a signal to be sent by the antenna 106 and demodulating a signal received by the antenna 106. The wireless device 103 includes a circuit for converting between a baseband signal and an electric signal. The wireless device 103 and the antenna 106 support IEEE.802.15.4, for example. A signal received by the antenna 106 and processed by the wireless device 103 is output to the controller 101. The wireless device 103 receives the signal from the controller 101, converts the received signal from a baseband signal to an electric signal, modulates the electric signal, and outputs the modulated signal to the antenna 106. The wireless device 103 is an example of a “wireless communication device”.

The clock 104 sends a clock signal of a predetermined clock frequency to the controller 101. The controller 101 executes a process in synchronization with the clock signal from the clock 104. The clock signal of the clock 104 is used to measure time and a time period.

The power feeder 105 supplies power to the hardware constituent elements. The power feeder 105 is electrically connected to the hardware constituent elements, although the electrical connections are not illustrated. If the GW 1 is operated by a battery, the power feeder 105 includes a button or pin lithium battery, a solar battery, or the like.

The network interface 107 receives and outputs information from and to a network. The network interface 107 is connected to the higher-level network. The network interface 107 includes an interface to be connected to a wired network and an interface to be connected to a wireless network. The network interface 107 is, for example, a network interface card (NIC), a wireless local area network (LAN) card, or the like.

The hardware configuration of the GW 1 illustrated in FIG. 5 is an example and is not limited to the configuration described above. One or more of the constituent elements may be omitted and replaced with another element, and another constituent element may be added to the GW 1 in the first embodiment. For example, the GW 1 may include a portable storage medium driving device and execute a program stored in a portable storage medium. The portable storage medium is, for example, an SD card, a mini SD card, a micro SD card, a Universal Serial Bus (USB) flash memory, a compact disc (CD), a digital versatile disc (DVD), a Blu-ray (registered trademark) disc, a flash memory card, or the like.

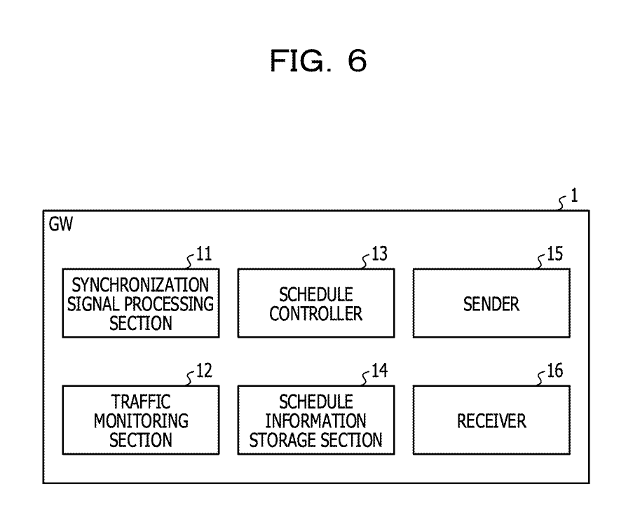

FIG. 6 is a diagram illustrating an example of a functional configuration of the GW 1. The GW 1 includes, as functional constituent elements, a synchronization signal processing section 11, a traffic monitoring section 12, a schedule controller 13, a schedule information storage section 14, a sender 15, and a receiver 16.

The sender 15 and the receiver 16 are interfaces with the wireless device 103. The synchronization signal processing section 11 generates a synchronization signal in accordance with an instruction received from the schedule controller 13. The instruction to generate the synchronization signal is input to the synchronization signal processing section 11 at predetermined time in a synchronization signal period of a superframe. The synchronization signal includes information identifying the GW 1 and schedule information, for example. The synchronization signal is broadcast. The schedule information includes version information and the active time length Ta, for example. The version information and the active time length Ta are determined by the schedule controller 13 and stored in the schedule information storage section 14. The synchronization signal processing section 11 reads the schedule information stored in the schedule information storage section 14 and causes the schedule information to be included in the synchronization signal. The generated synchronization signal is output to the sender 15 and sent via the wireless device 103 and the antenna 106. The sender 15, the receiver 16, and the synchronization signal processing section 11 are functional constituent elements achieved by causing the processor of the GW 1 to execute the wireless communication program.

Since the first embodiment assumes that the active periods and sleep periods of the superframes are set as illustrated in FIG. 2, an active time length Ta is included in schedule information of each of the GW 1 and nodes 2. Schedule information of each of the GW 1 and nodes 2 may include a sleep period Tp. If multiple active periods are included in each of the superframes, schedule information includes, for each of the active periods, two or more of the start time of the active period, the end time of the active period, and the length of the active period. The start time and end time of the active periods are identified by time lengths from the start of the superframe.

The traffic monitoring section 12, the schedule controller 13, and the schedule information storage section 14 are functional constituent elements achieved by causing the processor of the GW 1 to execute the scheduling program 102P. The traffic monitoring section 12 monitors the wireless device 103 and monitors traffic sent and received by the wireless device 103. The traffic monitoring section 12 records operating time of the wireless device 103 to execute sending and reception processes, sending time, reception time, a sending source, a receiving destination, and the like in a traffic monitoring storage region (not illustrated) included in the memory 102. In addition, if relay history records are included in a packet, the traffic monitoring section 12 records the amount, stored in the packet, of unsent data stored in a sending queue in the traffic monitoring storage region included in the memory 102.

The traffic monitoring section 12 starts and terminates the traffic monitoring in accordance with instructions received from the schedule controller 13. For example, an instruction to start the traffic monitoring is input to the traffic monitoring section 12 at the start of an active period. For example, an instruction to terminate the traffic monitoring is input to the traffic monitoring section 12 at the start of a sleep period.

In an active period, the schedule controller 13 acquires information to be used to calculate a congestion parameter. When a sleep period starts, the schedule controller 13 calculates the congestion parameter and determines the active time length Ta based on the congestion parameter. The information to be used to calculate the congestion parameter is acquired from the traffic monitoring storage region included in the memory 102 and storing the results of the traffic monitoring by the traffic monitoring section 12, for example. When the active time length Ta is changed, the schedule controller 13 updates the version information. The version information is a number indicating a version and is updated by adding 1 to the number, for example.

The schedule controller 13 causes the determined active time length Ta and the updated version information to be stored in the schedule information storage section 14. In addition, the schedule controller 13 outputs an instruction to generate the synchronization signal to the synchronization signal processing section 11 at predetermined time in a synchronization signal period. The schedule controller 13 may determine a sleep time length Tp. Specifically, the schedule controller 13 determines the schedule information.

The schedule controller 13 controls starts and ends of active and sleep periods in accordance with a timer and the schedule information stored in the schedule information storage section 14. At the end of a sleep period, the schedule controller 13 turns on the wireless device 103 and activates the sender 15 and the receiver 16. At the end of an active period and the start of a sleep period, the schedule controller 13 turns off the wireless device 103 and deactivates the sender 15 and the receiver 16.

Hereinafter, a state in which the wireless device 103 is turned on and the sender 15 and the receiver 16 are activated is referred to as active mode, while a state in which the wireless device 103 is turned off and the sender 15 and the receiver 16 are deactivated is referred to as sleep mode. The state in which the wireless device 103 is turned on indicates a state in which power is supplied to the wireless device 103. The state in which the wireless device 103 is turned off indicates a state in which the supply of power to the wireless device 103 is stopped. The synchronization signal is sent and received in a synchronization signal period. Thus, when the GW 1 is in the synchronization signal period, the GW 1 is in the active mode. Thus, the sleep mode is switched to the active mode at the end of a sleep period.

The schedule information storage section 14 stores the schedule information. The schedule information storage section 14 is generated in the memory 102 of the GW 1. In the first embodiment, the active time length Ta and the version information are stored in the schedule information storage section 14. The schedule controller 13 determines a synchronization signal period and the starts and ends of active and sleep periods in accordance with the active time length Ta stored in the schedule information storage section 14. The functional constituent elements of the GW 1 illustrated in FIG. 6 may be achieved by hardware such as a field programmable gate array (FPGA), for example.

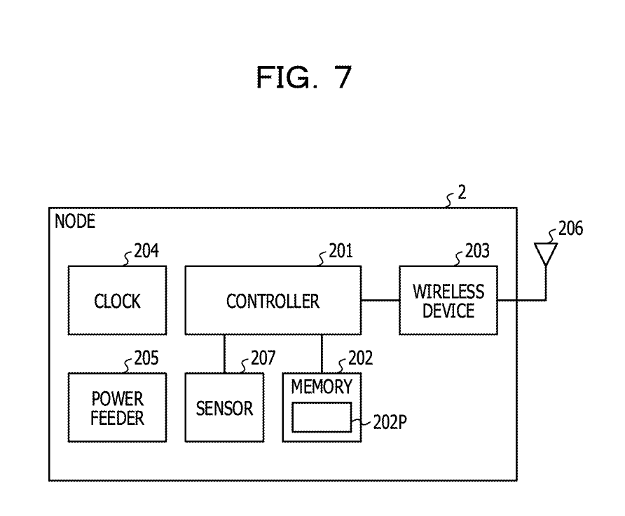

FIG. 7 is a diagram illustrating an example of a hardware configuration of each of the sensor nodes 2. Each of the nodes 2 is a device that includes a sensor and a wireless communication function. Each of the nodes 2 includes, as hardware constituent elements, a controller 201, a memory 202, a wireless device 203, a clock 204, a power feeder 205, an antenna 206, and a sensor 207. The controller 201, the memory 202, the wireless device 203, the clock 204, and the antenna 206 are the same as or similar to the controller 101, memory 102, wireless device 103, clock 104, and antenna 106 of the GW 1, respectively.

In the memory 202 of the node 2, a communication control program 202P is stored. The communication control program 202P is executed to switch between a synchronization signal period, an active period, and a sleep period in accordance with the synchronization signal of the GW 1 and execute wireless communication.

Since the sensor node 2 is a battery-operated device, the power feeder 205 includes a battery. The battery included in the sensor node 2 is a button or pin lithium battery, for example. The battery included in the sensor node 2 may be a solar battery or the like.

The sensor 207 monitors any or a combination of a temperature, humidity, acceleration, pressure, vibration, magnetism, a current, a voltage, and the like, for example. The sensor 207 executes the monitoring during a predetermined period or in response to the occurrence of a predetermined event and outputs the results of the monitoring to the controller 201. The hardware configuration of the node 2 is not limited to the configuration illustrated in FIG. 7.

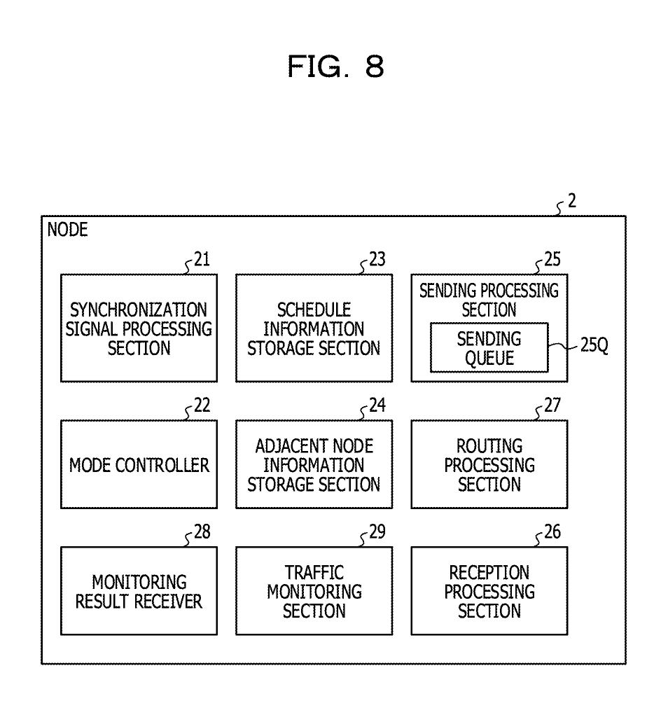

FIG. 8 is a diagram illustrating an example of a functional configuration of each of the sensor nodes 2. Each of the nodes 2 includes, as functional constituent elements, a synchronization signal processing section 21, a mode controller 22, a schedule information storage section 23, an adjacent node information storage section 24, a sending processing section 25, a reception processing section 26, a routing processing section 27, and a monitoring result receiver 28. In the first embodiment, a traffic monitoring section 29 is not included in each of the nodes 2. The traffic monitoring section 29 is described in a second embodiment. In each of the nodes 2, the functional constituent elements are achieved by causing the controller 201 to execute the communication control program 202P. The functional constituent elements of the sensor node 2 illustrated in FIG. 8 may be achieved by hardware such as an FPGA, for example.

If a destination of a packet received by a reception processing section 26 of a certain node 2 is the certain node 2, the reception processing section 26 of the certain node 2 outputs the packet to a target functional constituent element of the certain node 2. If a destination of a packet received by a reception processing section 26 of a certain node 2 is another node 2, the reception processing section 26 outputs the packet to a routing processing section 27 of the certain node 2. If a packet received by the reception processing section 26 is a synchronization signal, the reception processing section 26 outputs the packet to the synchronization signal processing section 21.

The synchronization signal processing section 21 receives, from the reception processing section 26, the synchronization signal sent by another node 2. If schedule information included in the received synchronization signal is newer than schedule information stored in the schedule information storage section 23, the synchronization signal processing section 21 writes the schedule information included in the received synchronization signal over the schedule information stored in the schedule information storage section 23. Whether or not the schedule information included in the received synchronization signal is newer than the schedule information stored in the schedule information storage section 23 is determined based on version information included in the schedule information.

In addition, the synchronization signal processing section 21 generates a synchronization signal at predetermined time in a synchronization signal period of a superframe. In the generated synchronization signal, the schedule information stored in the schedule information storage section 23 is stored. The generated synchronization signal is output to the sending processing section 25 and output to the wireless network via the wireless device 203 and the antenna 206. The synchronization signal sent by the node 2 is used to notify other nodes 2 of the synchronization signal from the GW 1. This notifies the other nodes 2 separated by longer distances from the GW 1 than the target node 2 of the synchronization signal sent by the GW 1.

The mode controller 22 controls, in accordance with the schedule information stored in the schedule information storage section 23, the starts and ends of a synchronization signal time period, active period, and sleep period of the node 2. When the sleep period ends, the mode controller 22 turns on the wireless device 203 and activates the sending processing section 25, the reception processing section 26, and the routing processing section 27. When the active period ends and the sleep period starts, the mode controller 22 turns off the wireless device 203 and deactivates the sending processing section 25, the reception processing section 26, and the routing processing section 27. In addition, the mode controller 22 notifies the sending processing section 25 of the start of the active period.

In the active mode of the node 2, the wireless device 203 is in an ON state, and the sending processing section 25, the reception processing section 26, and the routing processing section 27 are in activated states. In the sleep mode of the node 2, the wireless device 203 is in an OFF state, and the sending processing section 25, the reception processing section 26, and the routing processing section 27 are in deactivated states.

The monitoring result receiver 28 receives the monitoring results from the sensor 207, generates a packet including the monitoring results, and outputs the generated packet to the routing processing section 27.

The routing processing section 27 determines transfer destinations of packets received from the reception processing section 26 and the monitoring result receiver 28 and outputs the packets to the sending processing section 25. The transfer destinations of the packets are determined based on an adjacent node information table stored in the adjacent node information storage section 24, for example.

The sending processing section 25 outputs packets received from the routing processing section 27 and the synchronization signal processing section 21 to the wireless device 203. The sending processing section 25 includes a sending queue 25Q. The sending queue 25Q is a region included in a memory of the controller 201. The sending queue 25Q is a First In First Out (FIFO) queue. The packets input to the sending processing section 25 are stored in the sending queue 25Q. The sending processing section 25 starts and stops an operation in accordance with instructions from the node controller 22. When receiving a notification indicating the start of an active period from the mode controller 22, the sending processing section 25 starts a sending process of outputting packets stored in the sending queue 25Q to the wireless device 203 in the order in which the packets have been input to the sending processing section 25. When the amount of unsent data stored in the node 2 is to be notified, the sending processing section 25 adds the amount, stored in the sending queue 25Q, of the unsent data to a packet (refer to FIG. 3).

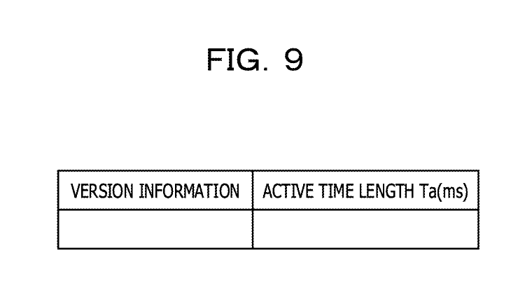

FIG. 9 is a diagram illustrating an example of the schedule information stored in the schedule information storage section 23. The schedule information storage section 23 is generated in the memory 202 of the node 2. Version information and an active time length Ta are stored in the schedule information storage section 23, for example. The active time length Ta is in milliseconds, for example.

The schedule information stored in the schedule information storage section 14 of the GW 1 is the same as or similar to schedule information stored in the schedule information storage sections 23 of the nodes 2.

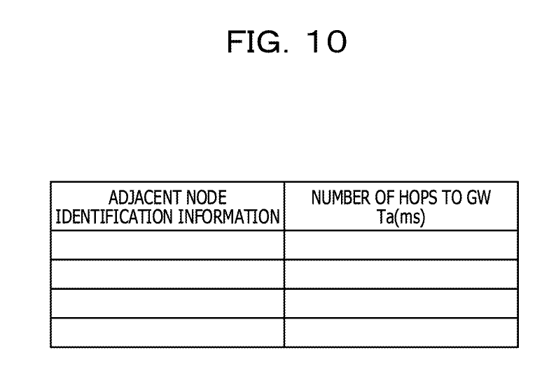

FIG. 10 illustrates an example of the adjacent node information table stored in the adjacent node information storage section 23. The adjacent node information storage section 23 is generated in the memory 202 of the node 2. In the adjacent node information table, information that indicates adjacent nodes 2 from which the target node 2 receives predetermined signals is stored.

In the adjacent node information table, adjacent node identification information and the numbers of hops to the GW 1 are stored. In the adjacent node information table, MAC addresses of the adjacent nodes 2 are stored. The numbers of hops to the GW 1 are the numbers of nodes 2 via which a signal or a packet is sent from the target node 2 to the GW 1. The information included in the adjacent node information table is included in a synchronization signal, a control signal for a routing protocol, or the like and notified.

The first embodiment assumes that a unicast packet is not sent by the GW 1 to the nodes 2 in a downstream direction. In the first embodiment, therefore, a unicast packet to be processed by the routing processing section 27 is limited to a packet to be sent to the GW 1. When receiving a packet to be sent to the GW 1, the routing processing section 27 selects, from among adjacent nodes indicated in the adjacent node information table, an adjacent node associated with the smallest number of hops to the GW 1, sets the selected adjacent node to a transfer destination, and outputs the packet to the sending processing section 25.

The sensor network system 100, however, may be a system in which a unicast packet is sent by the GW 1 to a sensor node 2 in a downstream direction and in which a unicast packet is sent by a sensor node 2 to another sensor node 2. In this case, each of the sensor nodes 2 has a routing table and holds, in the routing table, information of paths extending to the other sensor nodes 2.

In addition, the sensor network system 100 may be a system in which, if a transfer destination of a packet is not indicated in an adjacent node information table of a node 2, the routing processing section 27 of the node 2 executes the backtracking to return the packet to a sending source of the packet. If any or a combination of the rate of executing the backtracking using relay history records and the rate of increase in the number of relay nodes is used as a congestion parameter or congestion parameters, the routing processing section 27 writes the relay history records in a network header of a packet (refer to FIG. 4).

Flow of Process

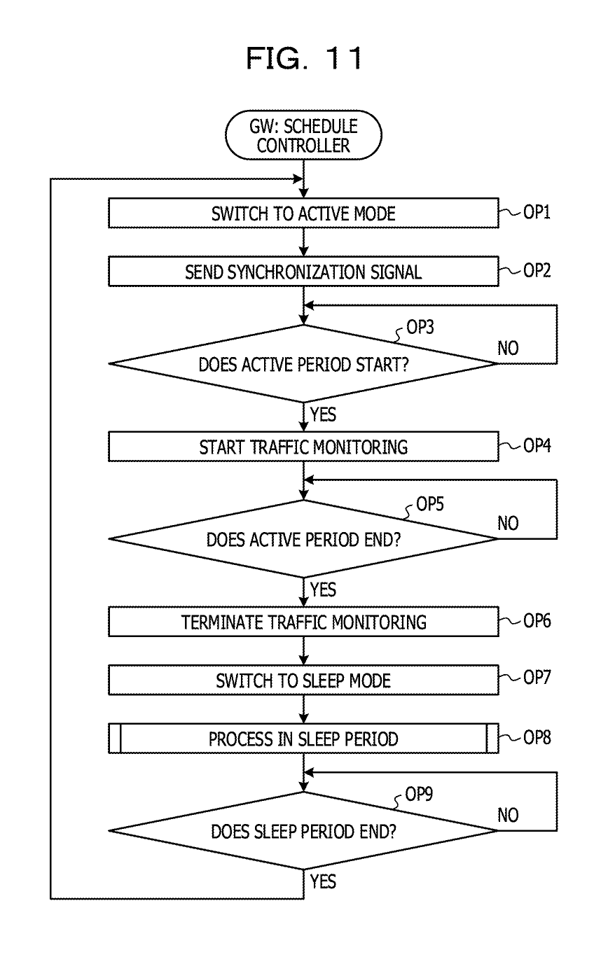

FIG. 11 illustrates an example of a flowchart of a process to be executed by the schedule controller 13 of the GW 1. The process illustrated in FIG. 11 is started upon the activation of the GW 1. A main section for executing the process illustrated in FIG. 11 is the processor of the controller 101. For convenience sake, however, the schedule controller 13 that is a functional constituent element is described as a main section for executing the process illustrated in FIG. 11.

In OP1, a superframe or a synchronization signal period of the superframe starts, and the schedule controller 13 switches the mode to the active mode. Specifically, the schedule controller 13 turns on the wireless device 103 and activates the sender 15 and the receiver 16.

In OP2, the GW 1 is in the synchronization signal period and the schedule controller 13 instructs the synchronization signal processing section 11 to generate a synchronization signal at predetermined time. The synchronization signal processing section 11 receives the instruction from the schedule controller 13, generates the synchronization signal, and sends the synchronization signal to the wireless network via the sender 15. In the synchronization signal, the schedule information stored in the schedule information storage section 14 is stored. In the schedule information, the version information and the active time length Ta are stored. If the synchronization signal is sent for the first time, initial values set in advance are used as the version information and the active time length Ta.

In OP3, the schedule controller 13 determines whether or not the GW 1 is at the start of the active period. In the first embodiment, whether or not the GW 1 is the start of the active period is determined based on whether or not the entire synchronization signal period has elapsed after the start of the synchronization signal period or based on a timer that starts to count down time upon the start of the synchronization signal period from time corresponding to the length of the synchronization signal period from the start of the synchronization signal period. If the GW 1 is not at the start of the active period (NO in OP3), the schedule controller 13 is in a standby state. If the GW 1 is at the start of the active period (YES in OP3), the process proceeds to OP4.

In OP4, the active period has started and the schedule controller 13 notifies the traffic monitoring section 12 of an instruction to start the traffic monitoring.

In OP5, the schedule controller 13 determines whether or not the GW 2 is at the end of the active period. In the first embodiment, whether or not the GW 1 is at the end of the active period is determined based on whether time corresponding to the active time length Ta has elapsed after the start of the active period or based on the timer that starts to count down time upon the start of the active period from time corresponding to the active time length Ta from the start of the active period. If the GW 1 is not at the end of the active period (NO in OP5), the schedule controller 13 is in the standby state. If the GW 1 is at the end of the active period (YES in OP5), the process proceeds to OP6.

In OP6, the active period has ended, a sleep period has started, and the schedule controller 13 notifies the traffic monitoring section 12 of an instruction to terminate the traffic monitoring.

In OP7, the schedule controller 13 switches the active mode to the sleep mode. Specifically, the schedule controller 13 turns off the wireless device 103 and deactivates the sender 15 and the receiver 16.

In OP8, the schedule controller 13 executes a process in the sleep period. In the process executed in the sleep period, the active time length Ta is determined based on a congestion parameter. The process executed in the sleep period is described later in detail.

In OP9, the schedule controller 13 determines whether or not the GW 1 is at the end of the sleep period. In the first embodiment, whether or not the GW 1 is at the end of the sleep period is determined based on whether or not time corresponding to the sleep time length Tp has elapsed after the start of the sleep period or based on the timer that counts down time upon the start of the sleep period from time corresponding to the sleep time length Tp from the start of the sleep period. If the GW 1 is not at the end of the sleep period (NO in OP9), the schedule controller 13 is in the standby state. If the GW 1 is at the end of the sleep period (YES in OP9), the process illustrated in FIG. 11 proceeds to OP1 and is repeatedly executed.

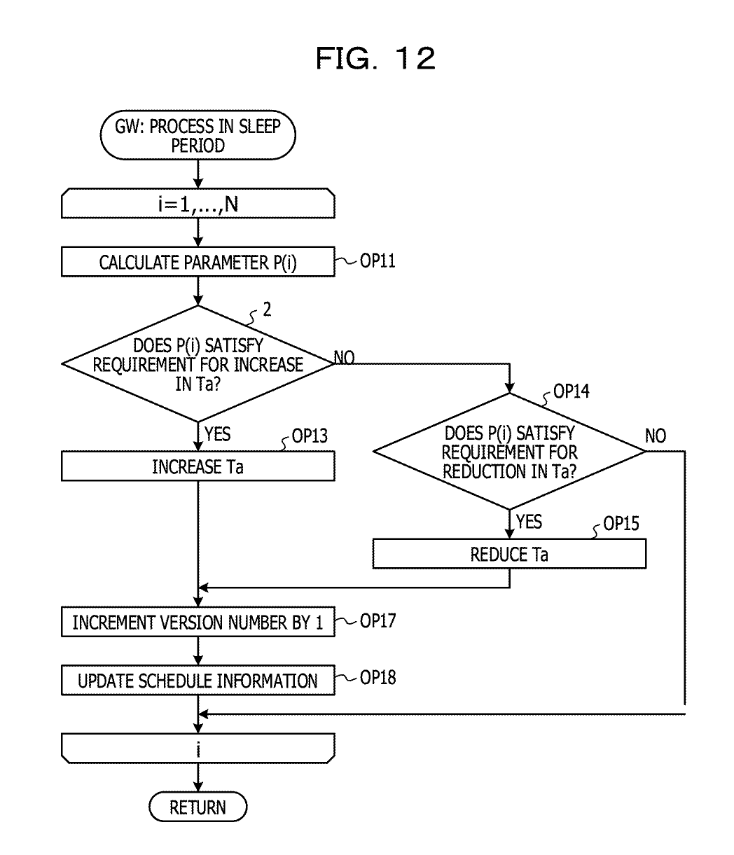

FIG. 12 illustrates an example of a flowchart of the process to be executed by the schedule controller 13 of the GW 1 in the sleep period of the GW 1. The process illustrated in FIG. 12 corresponds to the process of OP8 illustrated in FIG. 11.

Processes of OP11 to 17 are repeatedly executed for the number of congestion parameters P(i). In this case, i indicates an integer in a range of 1 to N and is a variable serving as a pointer indicating a congestion parameter, and N indicates the number of the congestion parameters. For example, if the congestion ratio, the rate of executing the backtracking, and the rate of increase in the number of relay nodes are used as the congestion parameters, the congestion ratio is indicated by P(1), the rate of executing the backtracking is indicated by P(2), the rate of increase in the number of relay nodes is indicated by P(3), and N=3.

In OP11, the schedule controller 13 calculates a congestion parameter P(i). In OP12, the schedule controller 13 determines whether or not the congestion parameter P(i) satisfies a requirement for an increase in the active time length Ta. If the congestion parameter P(i) satisfies the requirement for the increase in the active time length Ta (YES in OP12), the process proceeds to OP13. If the congestion parameter P(i) does not satisfy the requirement for the increase in the active time length Ta (NO in OP12), the process proceeds to OP14.

In OP13, the congestion parameter P(i) satisfies the requirement for the increase in the active time length Ta, and the schedule controller 13 increases the active time length Ta. In this case, the active time length Ta is increased by a predetermined value, a value based on the value of the congestion parameter P(i), or the like, for example. A method for increasing the active time length Ta is not limited to a specific method.

In OP14, the schedule controller 13 determines whether or not the congestion parameter P(i) satisfies a requirement for a reduction in the active time length Ta. If the congestion parameter P(i) satisfies the requirement for the reduction in the active time length Ta (YES in OP14), the process proceeds to OP15. If the congestion parameter P(i) does not satisfy the requirement for the reduction in the active time length Ta (NO in OP14) and i<N, the process of OP11 is executed on a next congestion parameter. If the congestion parameter P(i) does not satisfy the requirement for the reduction in the active time length Ta (NO in OP14) and i=N, the process illustrated in FIG. 12 is terminated and the process illustrated in FIG. 11 proceeds to OP9 illustrated in FIG. 11.

The requirements for the increase and reduction in the active time length Ta depend on a relative magnitude of the congestion parameter with respect to thresholds. The thresholds may be the same value or different from each other.

In OP15, the congestion parameter P(i) satisfies the requirement in the reduction in the active time length Ta, and the schedule controller 13 reduces the active time length Ta. In this case, the active time length Ta is reduced by a predetermined value, a value based on the value of the congestion parameter P(i), or the like, for example. A method for reducing the active time length Ta is not limited to a specific method.

Since the active time length Ta is changed in OP13 or OP15, the schedule controller 13 adds 1 to the value of the version information, thereby updating the version information in OP16. In OP17, the schedule controller 13 updates the schedule information stored in the schedule information storage section 14 so that the schedule information includes the updated active time length Ta and the updated version information. After that, if i<N, the process of OP11 is executed on the next congestion parameter. If i=N, the process illustrated in FIG. 12 is terminated and the process illustrated in FIG. 11 proceeds to OP9 illustrated in FIG. 11.

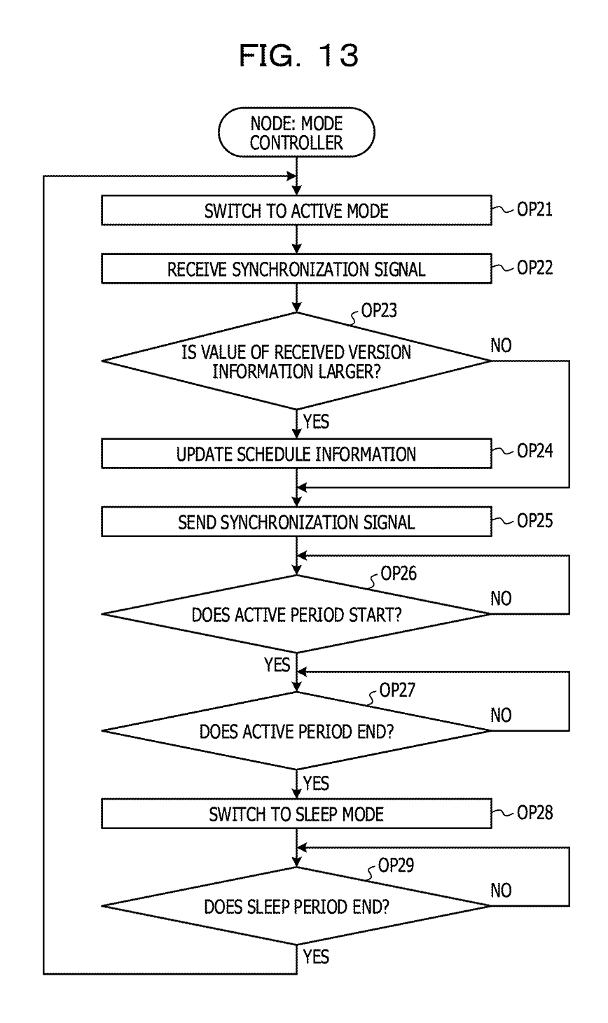

FIG. 13 illustrates an example of a flowchart of a process to be executed by a mode controller 22 of each of the nodes 2. The process illustrated in FIG. 13 is started upon the activation of the node 2. A main section for executing the process illustrated in FIG. 13 is a processor of the controller 201. For convenience sake, however, a functional constituent element is described as a main section for executing the process illustrated in FIG. 13.

In OP21, a superframe or a synchronization signal period of the superframe starts, and the mode controller 22 switches the mode to the active mode. Specifically, the mode controller 22 turns on the wireless device 203 and activates the sending processing section 25, the reception processing section 26, and the routing processing section 27.

In OP22, the node 2 is in the synchronization signal period and a synchronization signal is received by the reception processing section 26 from the GW 1 or another node 2. Schedule information included in the synchronization signal received from the synchronization signal processing section 21 is input to the mode controller 22.

In OP23, the mode controller 22 determines whether or not a value of version information of the input schedule information is larger than a value of version information of schedule information stored in the schedule information storage section 24. If the value of the version information of the input schedule information is larger than the value of the version information of the schedule information stored in the schedule information storage section 24 (YES in OP23), the process proceeds to OP24. If the value of the version information of the input schedule information is equal to or smaller than the value of the version information of the schedule information stored in the schedule information storage section 24 (NO in OP23), the process proceeds to OP25.

In OP24, the mode controller 22 writes the input schedule information over the schedule information stored in the schedule information storage section 24, thereby updating the schedule information.

In OP25, the mode controller 22 outputs an instruction to generate a synchronization signal to the synchronization signal processing section 21 at predetermined time in the synchronization signal period. When receiving the instruction to generate the synchronization signal, the synchronization signal processing section 21 generates the synchronization signal including the schedule information stored in the schedule information storage section 24 and sends the generated synchronization signal to the wireless network via the sending processing section 25.

Since the synchronization signal is sent in the synchronization signal period so that the sent synchronization signal does not collide with a signal sent by another node 2, the process of sending the synchronization signal in OP25 may be executed before the process of receiving the synchronization signal in OP22. In addition, in the process of receiving the synchronization signal, synchronization signals sent by multiple devices may be received by the reception processing section 26, instead of the reception of the synchronization signal from the single device (GW 1 or the other node 2). Thus, the processes of OP22, OP23, and OP24 are executed every time a synchronization signal is received in OP22.

In OP26, the mode controller 22 determines whether or not the node 2 is at the start of an active period. If the node 2 is not at the start of the active period (NO in OP26), the mode controller 22 is in a standby state. If the node 2 is at the start of the active period (YES in OP26), the process proceeds to OP27.

When the active period starts, the mode controller 22 instructs the sending processing section 25 to start a sending process. The sending processing section 25 sends a packet stored in the sending queue 25Q to the wireless network via the wireless device 203. When the amount of unsent data stored in the sending queue 25Q is to be notified to the GW 1, the sending processing section 25 adds the amount of the unsent data stored in the sending queue 25Q to the packet. If the frame format with relay history records added thereto is used, the sending processing section 25 adds the relay history records to the packet.

The reception processing section 26 may receive a packet from another node 2 in the active period, and the results of the monitoring by the sensor 207 may be input to the monitoring result receiver 28. When the reception processing section 26 receives the packet from the other node 2, the received packet is output by the reception processing section 26 to the routing processing section 27 and stored in the sending queue 25Q of the sending processing section 25 from the routing processing section 27. In addition, if the sensor 207 executes the monitoring, a packet including the results of the monitoring is stored in the sending queue 25Q of the sending processing section 25 from the monitoring result receiver 28.

In OP27, the mode controller 22 determines whether or not the node 2 is at the end of the active period. If the node 2 is not at the end of the active period (NO in OP27), the mode controller 22 is in the standby state. If the node 2 is at the start of the active period (YES in OP27), the process proceeds to OP28.

In OP28, the active period has ended, a sleep period has started, and the mode controller 22 switches the mode to the sleep mode. Specifically, the mode controller 22 turns off the wireless device 203 and deactivates the sending processing section 25, the reception processing section 26, and the routing processing section 27.

In OP29, the mode controller 22 determines whether or not the node 2 is at the end of the sleep period. If the node 2 is not at the end of the sleep period (NO in OP29), the mode controller 22 is in the standby state. If the node 2 is at the end of the sleep period (YES in OP29), the process illustrated in FIG. 13 proceeds to OP21 and is repeatedly executed.

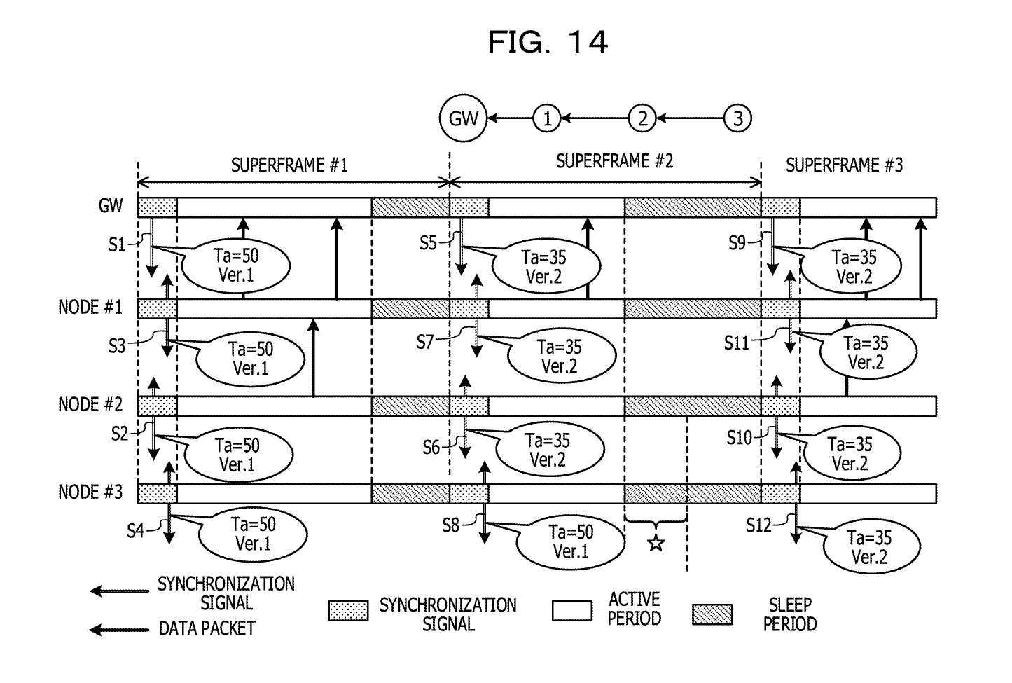

FIG. 14 is a diagram illustrating an example of the notification of a change in the active time length Ta to the nodes 2. FIG. 14 selectively illustrates the GW 1, a node #1, a node #2, and a node #3. A transmission path from the GW 1 to the node #3 extends from the GW 1 through the node #1 and the node #2 to the node #3. The node #1 may send a packet to the GW 1 without another relay node 2. Specifically, the node #1 is an adjacent node of the GW 1.

In FIG. 14, the abscissa indicates time. FIG. 14 illustrates the configurations of superframes of the GW1 and the nodes #1, #2, and #3. Synchronization signal periods are indicated by black patterns, active periods are indicated by white patterns, and sleep periods are indicated by hatched patterns.

It is assumed that synchronization signals are sent in the order of the GW 1, the node #2, the node #1, and the node #3 in each of the superframes. In an initial state illustrated in FIG. 14, each of the GW 1, the node #1, the node #2, and the node #3 holds schedule information indicating an active time length Ta of 50 milliseconds and a version 1.

S1 to S4 indicate processes executed in a synchronization signal period of a superframe #1. In S1, the GW 1 sends a synchronization signal including schedule information including the active time length Ta of 50 milliseconds and the version 1 (in OP2 illustrated in FIG. 11). The node #1 receives the synchronization signal from the GW 1 (in OP22 illustrated in FIG. 13). Since the schedule information has not been updated (NO in OP23 illustrated in FIG. 13), the schedule information held in the node #1 is not updated.

In S2, the node #2 sends a synchronization signal (in OP25 illustrated in FIG. 13). Schedule information included in the synchronization signal sent by the node #2 in S2 includes the active time length Ta of 50 milliseconds and the version 1. The synchronization signal sent by the node #2 reaches the node #1 and the node #3 (in OP22 illustrated in FIG. 13). However, since the schedule information has not been updated (NO in OP23 illustrated in FIG. 23), the schedule information held in the node #1 and the node #3 is not updated.

In S3, the node #1 sends a synchronization signal (in OP25 illustrated in FIG. 13). The schedule information included in the synchronization signal sent by the node #1 in S3 includes the active time length Ta of 50 milliseconds and the version 1. The synchronization signal sent by the node #1 reaches the node #2 (in OP22 illustrated in FIG. 13). However, since the schedule information has not been updated (NO in OP23 illustrated in FIG. 13), the schedule information held in the node #2 is not updated. The GW 1 receives the synchronization signal sent by the node #1, but ignores the synchronization signal sent by the other device.

In S4, the node #3 sends a synchronization signal (in OP25 illustrated in FIG. 13). The schedule information included in the synchronization signal sent by the node #3 in S4 indicates the active time length Ta of 50 milliseconds and the version 1. The synchronization signal sent by the node #3 reaches the node #2 (in OP22 illustrated in FIG. 13). However, since the schedule information has not been updated (NO in OP23 illustrated in FIG. 13), the schedule information held in the node #2 is not updated.

When the synchronization signal period of the superframe #1 ends, an active period starts for each of the GW 1 and the nodes #1, #2, and #3. In the superframe #1, the active time lengths Ta of the active periods of the GW 1 and the nodes #1, #2, and #3 are 50 milliseconds.

S5 to S8 indicate processes to be executed in a synchronization signal period of a superframe #2. In S5, the GW 1 sends a synchronization signal (in OP2 illustrated in FIG. 11). It is, however, assumed that the schedule information is updated to schedule information indicating an active time length Ta of 35 milliseconds and a version 2 in a sleep period of the superframe #1. Thus, the schedule information included in the synchronization signal sent in S5 includes the active time length Ta of 35 milliseconds and the version 2.

The node #1 receives the synchronization signal from the GW 1 (in OP22 illustrated in FIG. 13). The schedule information included in the synchronization signal received from the GW 1 indicates the version 2 and is newer than the schedule information held in the node #1 (YES in OP23 illustrated in FIG. 13), and the schedule information held in the node #1 is updated to the schedule information indicating the active time length Ta of 35 milliseconds and the version 2 (in OP24 illustrated in FIG. 13).

In S6, the node #2 sends a synchronization signal (in OP25 illustrated in FIG. 13). At the time when S6 is executed, the updated schedule information indicating the version 2 is not received by the node #2, and the schedule information included in the synchronization signal sent by the node #2 includes the active time length Ta of 50 milliseconds and the version 1. The synchronization signal sent by the node #2 reaches the node #1 (in OP22 illustrated in FIG. 13). However, since the schedule information held in the node #1 and indicating the version 2 is newer than the schedule information held in the node #2 (NO in OP23 illustrated in FIG. 13), the schedule information held in the node #1 is not updated. The synchronization signal sent by the node #2 reaches the node #3 (in OP22 illustrated in FIG. 13). However, since the version 1 indicated by the schedule information held in the node #2 is the same as the version 1 indicated by the schedule information held in the node #3 (NO in OP23 illustrated in FIG. 13), the schedule information held in the node #3 is not updated.

In S7, the node #1 sends a synchronization signal (in OP25 illustrated in FIG. 13). The schedule information included in the synchronization signal sent by the node #1 in S7 includes the active time length Ta of 35 milliseconds and the version 2. The node #2 receives the synchronization signal from the node #1 (in OP22 illustrated in FIG. 13). The schedule information included in the synchronization signal sent by the node #1 indicates the version 2 and is newer than the schedule information held in the node #2 (YES in OP23 illustrated in FIG. 13). Thus, the schedule information held in the node #2 is updated to the schedule information indicating the active time length Ta of 35 milliseconds and the version 2 (in OP24 illustrated in FIG. 13).

In S8, the node #3 sends a synchronization signal (in OP25 illustrated in FIG. 13). The schedule information included in the synchronization signal sent by the node #3 in S8 includes the active time length Ta of 50 milliseconds and the version 1. The node #2 receives the synchronization signal from the node #3 (in OP22 illustrated in FIG. 13). However, since the schedule information held in the node #2 and indicating the version 2 is newer than the schedule information held in the node #3 (NO in OP23 illustrated in FIG. 13), the schedule information held in the node #2 is not updated.

When the synchronization signal period of the superframe #2 ends, an active period starts for each of the GW 1 and the nodes #1, #2, and #3. In the superframe #2, the active time lengths Ta of the active periods of the GW 1 and the nodes #1 and #2 are 35 milliseconds, but the active time length Ta of the active period of the node #3 is 50 milliseconds. This is due to the fact that the node #3 has yet to receive the schedule information indicating the version 2.

S9 to S12 are processes to be executed in a synchronization signal period of a superframe #3. In S9, the GW sends a synchronization signal (in OP2 illustrated in FIG. 11). During a sleep period of the superframe #2, the schedule information is not updated and schedule information included in the synchronization signal sent in S9 indicates the active time length Ta of 35 milliseconds and the version 2.

The synchronization signal sent by the GW 1 reaches the node #1 (in OP22 illustrated in FIG. 13). However, since the schedule information has not been updated (NO in OP23 illustrated in FIG. 13), the schedule information held in the node #1 is not updated.

In S10, the node #2 sends a synchronization signal (in OP25 illustrated in FIG. 13). The schedule information included in the synchronization signal sent by the node #2 in S10 includes the active time length Ta of 35 milliseconds and the version 2. The synchronization signal sent by the node #2 reaches the node #1 (in OP22 illustrated in FIG. 13). However, since the node #1 holds the schedule information indicating the version 2 (NO in OP23 illustrated in FIG. 13), the schedule information held in the node #1 is not updated. The node #3 receives the synchronization signal from the node #2 (in OP22 illustrated in FIG. 13). Since the schedule information received by the node #3 is newer than the schedule information held in the node #3 and indicating the version 1 (YES in OP23 illustrated in FIG. 13), the node #3 updates the schedule information held in the node #3 to the schedule information indicating the active time length Ta of 35 milliseconds and the version 2 (in OP24 illustrated in FIG. 13).

In S11, the node #1 sends a synchronization signal (in OP25 illustrated in FIG. 13). The schedule information included in the synchronization signal sent by the node #1 in S11 indicates the active time length Ta of 35 milliseconds and the version 2. The node #2 receives the synchronization signal from the node #1 (in OP22 illustrated in FIG. 13). Since the node #2 already holds the schedule information indicating the version 2 (NO in OP23 illustrated in FIG. 13), the schedule information held in the node #2 is not updated.

In S12, the node #3 sends a synchronization signal (in OP25 illustrated in FIG. 13). The schedule information included in the synchronization signal sent by the node #3 in S12 includes the active time length Ta of 35 milliseconds and the version 2. The node #2 receives the synchronization signal from the node #3 (in OP22 illustrated in FIG. 13). Since the node #2 already holds the schedule information indicating the version 2 (NO in OP23 illustrated in FIG. 13), the schedule information held in the node #2 is not updated.

When the synchronization signal period of the superframe #3 ends, an active period starts for each of the GW 1 and the nodes #1, #2, and #3. In the superframe #3, the active time lengths Ta of the active periods of the GW 1 and the nodes #1, #2, and #3 are 35 milliseconds.

For example, as indicated in the example illustrated in FIG. 14, a change in the active time length Ta may not be notified to all the nodes within the sensor network system 100 in a single synchronization signal period, depending on the timing of sending synchronization signals from the devices. In this case, the active time lengths Ta of active periods of the nodes 2 are not equal and a period (indicated by a star sign in FIG. 14) during which the upstream-side node #2 is in a sleep period and the downstream-side node #3 is in an active period occurs. Even if the node #3 sends a packet in the period indicated by the star sign, the node #2 is in the sleep period and the packet sending fails. The packet tried to be sent by the node #3 in the period indicated by the star sign is sent in an active period of the next superframe #3 and is not lost.

Simulation

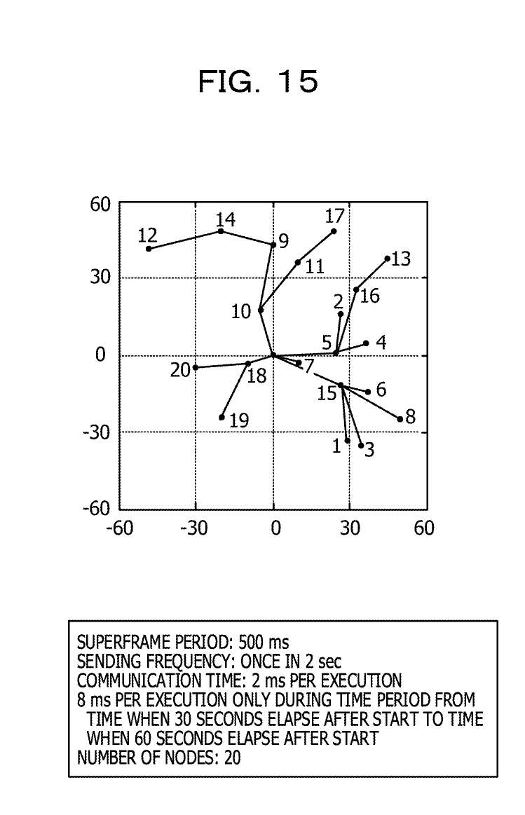

FIG. 15 is a diagram illustrating a configuration of the sensor network system 100 in a simulation according to the first embodiment. In the simulation, the sensor network system 100 includes the GW 1 and 20 sensor nodes 2. The simulation assumes that paths illustrated in FIG. 15 are set for the GW 1 and the 20 sensor nodes 2.

In the simulation, each of superframe periods (time lengths) is 500 milliseconds. Each of the frequencies of sending monitoring results of the sensor nodes 2 is once in every 2 seconds. Communication time for sending or transfer executed each time by each of the sensor nodes 2 is 2 milliseconds. During a time period from the time when 30 seconds elapse after the start of communication to the time when 60 seconds elapse after the start of the communication, communication time for sending or transfer executed each time by each of the sensor nodes 2 is 8 milliseconds.

In the simulation, paths extending from the nodes 2 to the GW 1 are fixed to the paths illustrated in FIG. 15. In the simulation, data is sent by the nodes 2 in predetermined periods, but data is not sent by the GW 1 to the nodes 2. In the simulation, time periods for synchronizing the superframes are not considered.

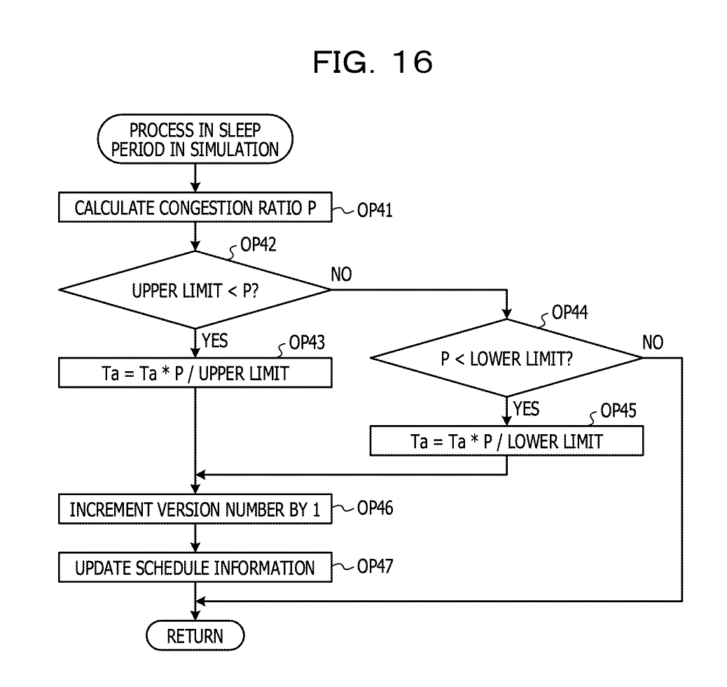

FIG. 16 is a flowchart of a process to be executed by the GW 1 in a sleep period of the GW 1 in the simulation according to the first embodiment. In the simulation, a congestion ratio P is used as a congestion parameter. The flowchart illustrated in FIG. 16 corresponds to the flowchart illustrated in FIG. 12 in the case where the congestion ratio P is used as the congestion parameter.

In OP41, the schedule controller 13 calculates the congestion ratio P. A time period for sending and reception by the wireless device 103 is acquired from the traffic monitoring storage region included in the memory 102 and storing the results of the monitoring by the traffic monitoring section 12 and is used to calculate the congestion ratio P. If the amount of unsent data stored in a sending queue of an adjacent node is used to calculate the congestion ratio P, the amount of the unsent data stored in the sending queue of the adjacent node is also acquired from the traffic monitoring storage region included in the memory 102.

In OP42, the schedule controller 13 determines whether or not the calculated congestion ratio P is larger than an upper limit. If the calculated congestion ratio P is larger than the upper limit, the congestion ratio P corresponds to the requirement for an increase in the active time length Ta. If the calculated congestion ratio P is larger than the upper limit (YES in OP42), the process proceeds to OP43. If the calculated congestion ratio P is equal to or smaller than the upper limit (NO in OP42), the process proceeds to OP44.

In OP43, the congestion ratio P satisfies the requirement for the increase in the active time length Ta, and the schedule controller 13 updates the active time length Ta to a value of (the active time length Ta×(the congestion ratio/the upper limit)).

In OP44, the schedule controller 13 determines whether or not the calculated congestion ratio P is smaller than a lower limit. If the calculated congestion ratio P is smaller than the lower limit, the congestion ratio P corresponds to the requirement for a reduction in the active time length Ta. If the congestion ratio P is smaller than the lower limit (YES in OP44), the process proceeds to OP45. If the congestion ratio P is equal to or larger than the lower limit (NO in OP44), the process illustrated in FIG. 16 is terminated.

In OP45, the congestion ratio P satisfies the requirement in the reduction in the active time length Ta, and the schedule controller 13 updates the active time length Ta to a value of (the active time length Ta×(the congestion ratio/the lower limit)).

In OP46, the schedule controller 13 increments the value of the version information by 1. In OP47, the schedule controller 13 writes the updated active time length Ta and the updated version information in the schedule information stored in the schedule information storage section 14, thereby updating the schedule information stored in the schedule information storage section 14. After that, the process illustrated in FIG. 16 is terminated.

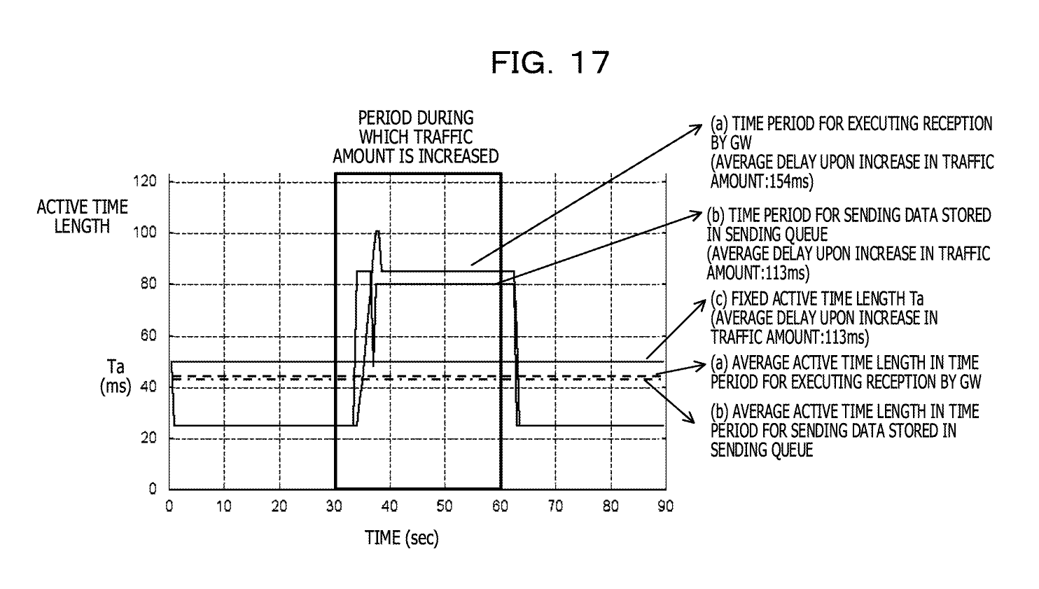

FIG. 17 is a graph illustrating monitoring results obtained in active periods of the GW 1 in the simulation according to the first embodiment. In the graph illustrated in FIG. 17, the abscissa indicates time, and the ordinate indicates an active time length Ta. In the simulation, active time lengths Ta are monitored every 2 seconds.

FIG. 17 illustrates (a) the results of the simulation executed under the conditions described with reference to FIG. 15 in the case where a time period, measured by the GW 1, for executing the reception process by the wireless device 103 is used for the congestion ratio, (b) the results of the simulation executed under the conditions described with reference to FIG. 15 in the case where the time period, measured by the GW 1, for executing the reception process by the wireless device 103 and a time period for sending unsent data stored in a sending queue of an adjacent node are used for the congestion ratio, and (c) the results of the simulation executed under the conditions described with reference to FIG. 15 in the case where the active time lengths Ta are a fixed value of 50 milliseconds.

In the simulation, a time period for communication executed each time during a time period from the time when 30 seconds elapse after the start of the simulation to the time when 60 seconds elapse after the start of the simulation is 8 milliseconds, and a traffic amount is tentatively increased. Thus, in graphs of the results (a) and (b), active time lengths Ta are changed to large values in a period during which the traffic amount is increased and in a period close to the period during which the traffic amount is increased. In a graph of the results (c), active periods are a fixed value, and active time lengths Ta do not vary even during the period during which the traffic amount is increased.

FIG. 17 illustrates average active time lengths Ta in the measured time period in the graphs of the results (a), (b), and (c). The average active time lengths Ta in the graphs of the results (a) and (b) are indicated by dotted lines in FIG. 17. In the graph of the results (c), the active time lengths Ta are the fixed value, and the graph of the measured results is the same as a graph of the average active time length Ta.

As illustrated in FIG. 17, the average active time lengths Ta in the graphs of the results (a) and (b) are lower than the average active time length Ta in the graph of the results (c). The lower active time lengths Ta indicate that consumed power is low. Thus, in this simulation, power consumed by the devices is reduced by the method for dynamically determining the active time length Ta based on the traffic amount of the GW 1 according to the first embodiment.

In the case where the results (a) are obtained, average delay of the arrival of a packet sent by a sending node 2 at the GW 1 in the period during which the traffic amount is increased is 154 milliseconds. In the case where the results (b) are obtained, average delay of the arrival of a packet sent by a sending node 2 at the GW 1 in the period during which the traffic amount is increased is 113 milliseconds. In the case where the results (c) are obtained, average delay of the arrival of a packet sent by a sending node 2 at the GW 1 in the period during which the traffic amount is increased is 343 milliseconds. Thus, in this simulation, the delay in the period during which the traffic amount is increased is reduced by the method for dynamically determining the active time length Ta based on the traffic amount of the GW 1 according to the first embodiment.

### Effects of First Embodiment

In the first embodiment, the GW 1 estimates the traffic amount, determines the active time length Ta based on the estimated traffic amount, and notifies the sensor nodes 2 of the determined active time length Ta. The sensor nodes 2 switch between active periods and sleep periods in accordance with the active time length Ta determined by the GW 1. If the traffic amount increases, the active time length Ta is increased. If the traffic amount is reduced, the active time length Ta is reduced. Thus, the active time length Ta is optimized. The active time length Ta and consumed power have a correlation in which when the active time length Ta is increased, the consumed power increases. Specifically, in the first embodiment, the active time length Ta is adjusted based on the traffic amount, and power to be consumed by the devices is adjusted based on the traffic amount and may be efficiently consumed without wasted power consumption. As a result, power may be saved. When the traffic amount increases, the active time length Ta is increased. Thus, even when the traffic amount increases, an increase in delay time may be suppressed.

If the amount, notified by an adjacent node, of unsent data stored in a sending queue of the adjacent node is used to calculate the congestion ratio that is one of the congestion parameters, an active time length Ta of a next superframe may be set so that the unsent data stored in the adjacent node is completely sent in the active period of the next superframe. As the amount, notified by the adjacent node, of the unsent data stored in the sending queue increases, the congestion ratio increases and the active time length Ta is increased. Thus, an increase in delay time in the case where traffic is concentrated on the adjacent node may be suppressed.

If relay history records that are included in a packet are used in a similar manner to congestion parameters including the rate of executing the backtracking and the rate of increase in the number of relay nodes, an increase in delay time in the case where traffic is concentrated on a downstream-side relay node due to the occurrence of a detour caused by an obstacle or the like may be suppressed.

### Modified Example of First Embodiment

In the first embodiment, it takes time to notify all the nodes 2 included in the sensor network system 100 of the schedule information updated by the GW 1. Thus, for example, in the period indicated by the star sign in FIG. 14 or a period during which a target device is in an active period and a destination node is in a sleep period, the target device may send a packet and the packet sending may fail.

For example, a node 2 that is separated by a long distance from the GW 1 may not send a packet during an end part of an active period and may avoid a failure of packet sending. The distance from the GW 1 is the number of hops (relay nodes) to the GW 1, for example. If the node 2 is set in the aforementioned manner, a period during which the node 2 separated by the long distance from the GW 1 is substantially able to send a packet is shorter than an active period, but the amount of traffic to be relayed by the node 2 separated by the long distance from the GW 1 is small in many cases. Thus, this setting does not adversely affect the node 2.

Specifically, for example, the node 2 may be set so that as the distance between the node 2 and the GW 1 is increased, the timing of sending a packet is set to be earlier in an active period. Thus, the node 2 separated by the long distance from the GW 1 may not send a packet during an end part of an active period.

In addition, for example, the maximum time by which active time lengths Ta are reduced is be set in advance, and if a remaining active period is equal to or shorter than the maximum time, a node 2 that does not directly communicate with the GW 1 may not send a packet. In this case, the node 2 separated by a long distance from the GW 1 may not send a packet during an end part of an active period.

A node 2 separated by a long distance from the GW 1 may not send a packet during an end part of an active period, and the requirement for a reduction in the active time length Ta may be stricter, for example. This is due to the fact that a period such as the period indicated by the star sign in FIG. 14 occurs when the active time length Ta is reduced.

### Second Embodiment

In the second embodiment, each of the GW 1 and the sensor nodes 2 within the sensor network system 100 autonomously determines schedule information of the device and notifies the other devices of the determined schedule information. Each of the sensor nodes 2 sends or transfers a packet in an active period of a transmission or transfer destination to which the packet is to be sent or transferred. In the second embodiment, a description common to the first embodiment is omitted.

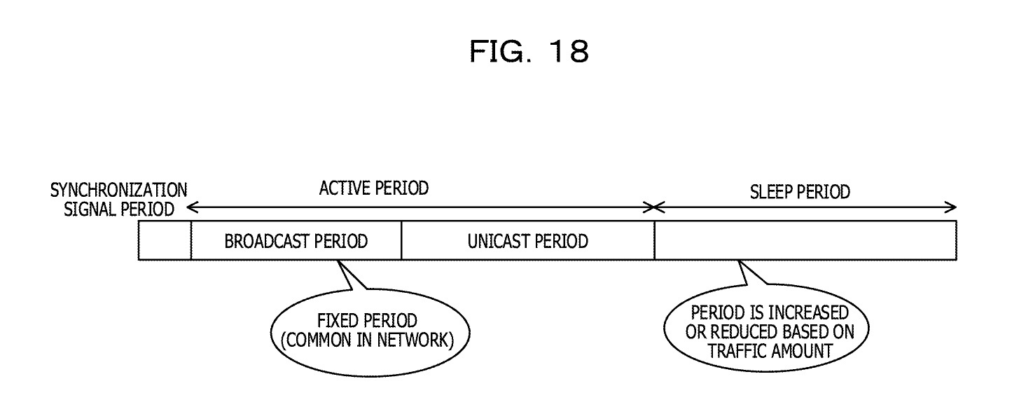

FIG. 18 is a diagram illustrating an example of the configuration of each of superframes according to the second embodiment. In the second embodiment, each of active periods is divided into a broadcast period and a unicast period. The order and length of the broadcast period are common to the devices included in the sensor network system 100. Specifically, the broadcast period is a period during which all the nodes 2 included in the sensor network system 100 are in active periods. It is likely that a broadcast packet includes data with a high degree of importance. Thus, in order to increase a probability of succeeding in packet sending, the broadcast packet is sent in a broadcast period. The unicast period varies based on a traffic amount. Thus, in the second embodiment, the active time lengths Ta are not shorter than the broadcast periods.

The order of broadcast and unicast periods of the active periods and sleep periods is not limited to that illustrated in FIG. 18. For example, the sleep periods may be immediately after the broadcast periods, and the unicast periods may be immediately after the sleep periods. The second embodiment assumes that each superframe with the configuration illustrated in FIG. 18 is used and that the order of the periods of each of the superframes is fixed. Thus, in the second embodiment, the nodes 2 and the GW 1 determine active time lengths Ta based on traffic amounts.

In the second embodiment, the nodes 2 and the GW 1 may determine the lengths of the unicast periods based on the traffic amounts, instead of the active time lengths Ta. In this case, each of the lengths of the unicast periods is an example of the “first time length”. If the order of the periods of each of the superframes is not fixed, each of the nodes 2 and the GW 1 determines two or more of the length of a unicast period, the start time of the unicast period, and the end time of the unicast period. Each of the broadcast periods is an example of the “first time length”. Each of the sensor nodes 2 according to the second embodiment is an example of the “wireless communication apparatus”.

A hardware configuration, functional configuration, and processes of the GW 1 described in the second embodiment are the same as or similar to those described in the first embodiment, and a description thereof is omitted. Configurations and processes of the nodes 2 described in the second embodiment are different from those described in the first embodiment.

Hardware configurations of the nodes 2 according to the second embodiment are the same as or similar to those described in the first embodiment. Functional configurations of the nodes 2 according to the second embodiment are different from the functional configurations described in the first embodiment, since traffic monitoring sections 29 are included in the nodes 2 according to the second embodiment. Each of the traffic monitoring sections 29 measures operating time of the wireless device 203 of the node 2 to execute a sending and reception process in an active period. Instructions to cause the traffic monitoring section 29 to start and terminate the measurement of the operating time of the wireless device 203 of the node 2 to execute the sending and reception process in the active period are input from the mode controller 22 upon the start and end of the active period.

In the second embodiment, in each of the nodes 2, schedule information determined by the mode controller 22 and held in the node 2 is stored in the schedule information storage section 23. The mode controller 22 switches between the active mode and the sleep mode in accordance with the schedule information stored in the schedule information storage section 23. In addition, the mode controller 22 calculates a congestion parameter, determines the schedule information stored in the node 2 based on the congestion parameter, and notifies the other nodes 2 of the determined schedule information. The node 2 uses a synchronization signal to notify the other nodes 2 of the schedule information stored in the node 2, for example.

When receiving schedule information from another node 2, the mode controller 22 records the received schedule information in an entry for the other node 2 in an adjacent node information table stored in the adjacent node information storage section 24. In the second embodiment, schedule information of each of the GW 1 and the nodes 2 includes an active time length Ta and version information.

In the second embodiment, the sending processing section 25 determines whether or not a destination node 2 is in an active period, whether a packet is a broadcast packet or a unicast packet, and whether the target node 2 is in a broadcast period or a unicast period, and the sending processing section 25 determines the timing of sending the packet. Details are described later.

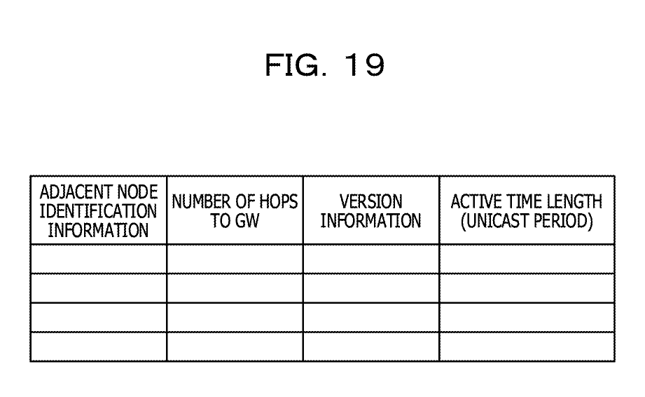

FIG. 19 illustrates an example of the adjacent node information table according to the second embodiment. In the second embodiment, the adjacent node information table includes adjacent node identification information, the number of hops to the GW 1, version information, and an active time length Ta. The version information and the active time length Ta are acquired from schedule information of a target device (GW 1 or a node 2). The schedule information is included in a synchronization signal sent by the target device.

When receiving information of a synchronization signal including the schedule information from the synchronization signal processing section 21, the mode controller 22 searches the adjacent node information table. If an entry for a corresponding node 2 does not exist in the adjacent node information table, and the mode controller 22 registers the received schedule information in the adjacent node information table. If the entry for the corresponding node 2 exists in the adjacent node information table, and the value of the received version information is larger than version information stored in the node 2, the entry of the adjacent node information table is updated to the received schedule information.

In addition, before sending a packet, the sending processing section 25 references the adjacent node information table and determines whether or not a destination device of the packet is in an active period.

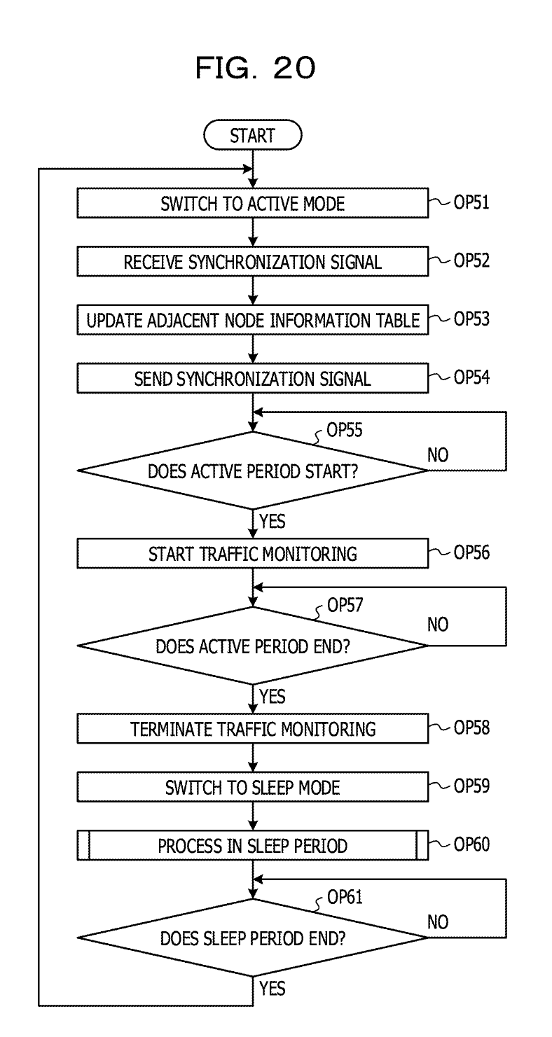

FIG. 20 is an example of a flowchart of a process to be executed by a mode controller 22 of each of the nodes 2 according to the second embodiment. The process illustrated in FIG. 20 is started upon the activation of the node 2.

In OP51, a synchronization signal period starts (or a superframe starts), and the mode controller 22 switches the mode to the active mode. Specifically, the mode controller 22 turns on the wireless device 203 and activates the sending processing section 25, the reception processing section 26, and the routing processing section 27.

In OP52, the node 2 is in the synchronization signal period, and a synchronization signal is received by the reception processing section 26 from the GW 1 or another node 2. The mode controller 22 receives schedule information included in the synchronization signal received from the synchronization signal processing section 21.

In OP53, if a value of version information of the received schedule information is larger than a value of version information indicated in an entry for the corresponding device in the adjacent node information table, the mode controller 22 updates the entry for the corresponding device in the adjacent node information table to the received schedule information.

In OP54, the mode controller 22 outputs an instruction to generate a synchronization signal to the synchronization signal processing section 21 at predetermined time in the synchronization signal period. The synchronization signal processing section 21 receives the instruction to generate the synchronization signal, generates the synchronization signal including schedule information stored in the schedule information storage section 23, and sends the generated synchronization signal to the wireless network via the sending processing section 25.

The reception of the synchronization signal is not limited to the reception from the single device (the GW 1 or another node 2), and the node 2 may receive synchronization signals from multiple devices. Thus, the processes of OP52 and OP53 are executed every time a synchronization signal is received.

In OP55, the mode controller 22 determines whether or not the node 2 is at the start of an active period. If the node 2 is not at the start of the active period (NO in OP55), the mode controller 22 is in the standby state. If the node 2 is at the start of the active period (YES in OP55), the process proceeds to OP56.

In OP56, the mode controller 22 instructs the traffic monitoring section 29 to start the traffic monitoring. When the active period starts, the mode controller 22 instructs the sending processing section 25 to start the sending process. When receiving the instruction from the mode controller 22, the sending processing section 25 starts sending a packet stored in the sending queue 25Q to the wireless network.

In OP57, the mode controller 22 determines whether or not the node 2 is at the end of the active period. If the node 2 is not at the end of the active period (NO in OP57), the mode controller 22 is in the standby state. If the node 2 is at the end of the active period (YES in OP57), the process proceeds to OP58.

In OP58, the active period has ended, and the mode controller 22 instructs the traffic monitoring section 29 to terminate the traffic monitoring due to the end of the active period.

In OP59, a sleep period has started, and the mode controller 33 switches the mode to the sleep mode due to the start of the sleep period. Specifically, the mode controller 22 turns off the wireless device 203 and deactivates the sending processing section 25, the reception processing section 26, and the routing processing section 27.

In OP60, the mode controller 22 executes a process in the sleep period. The process executed by the mode controller 22 in the sleep period is the same as or similar to the process illustrated in FIG. 12 and executed by the schedule controller 13 of the GW 1 in the sleep period. Specifically, the mode controller 22 calculates a congestion parameter and determines an active time length Ta based on the congestion parameter.

In OP61, the mode controller 22 determines whether or not the node 2 is at the end of the sleep period. If the node 2 is not at the end of the sleep period (NO in OP61), the mode controller 22 is in the standby state. If the node 2 is at the end of the sleep period (YES in OP61), the process illustrated in FIG. 20 proceeds to OP51 and is repeatedly executed.

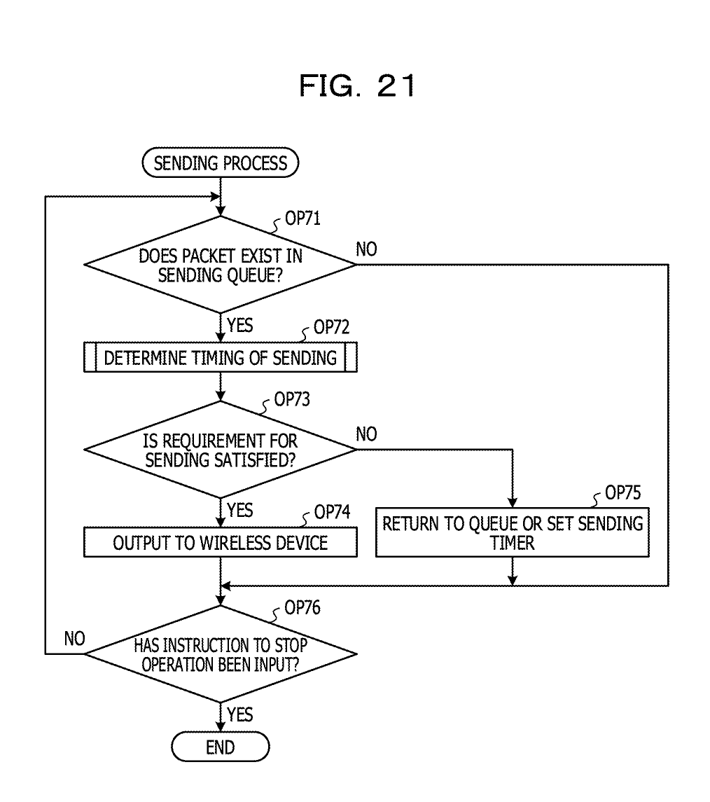

FIG. 21 is an example of a flowchart of a process to be executed by a sending processing section 25 of each of the nodes 2 according to the second embodiment. The process illustrated in FIG. 21 is started in response to a notification indicating the start of an active period and sent by the mode controller 22.

In OP71, the sending processing section 25 determines whether or not a packet is stored in the sending queue 25Q. If the packet is stored in the sending queue 25Q (YES in OP71), the process proceeds to OP72. If the packet is not stored in the sending queue 25Q (NO in OP71), the process proceeds to OP76.

In OP72, the sending processing section 25 executes a process of determining the timing of sending. The process of determining the timing of sending is a process of determining a requirement for packet sending. The process of determining the timing of sending is described later in detail.

In OP73, the sending processing section 25 determines whether or not the requirement, determined in the process of determining the timing of sending, for the packet sending is satisfied. If the requirement, determined in the process of determining the timing of sending, for the packet sending is satisfied (YES in OP73), the process proceeds to OP74. If the requirement, determined in the process of determining the timing of sending, for the packet sending is not satisfied (NO in OP73), the process proceeds to OP75.

In OP74, the sending processing section 25 outputs the packet to the wireless device 103 since the requirement, determined in the process of determining the timing of sending, for the packet sending is satisfied. After that, the packet is output by the wireless device 103 to the wireless network.

In OP75, the sending processing section 25 stores the packet in the sending queue 25Q again since the requirement, determined in the process of determining the timing of sending, for the packet sending is not satisfied. In OP75, the sending processing section 25 may set a sending timer so that the packet is sent in a broadcast period of a next superframe.

In OP76, the sending processing section 25 determines whether or not an instruction to stop an operation has been input from the mode controller 22. The instruction to stop the operation is input from the mode controller 22 upon the start of a sleep period. If the instruction to stop the operation has been input from the mode controller 22 (YES in OP76), the process illustrated in FIG. 21 is terminated. If the instruction to stop the operation has not been input from the mode controller 22 (NO in OP76), the process proceeds to OP71.

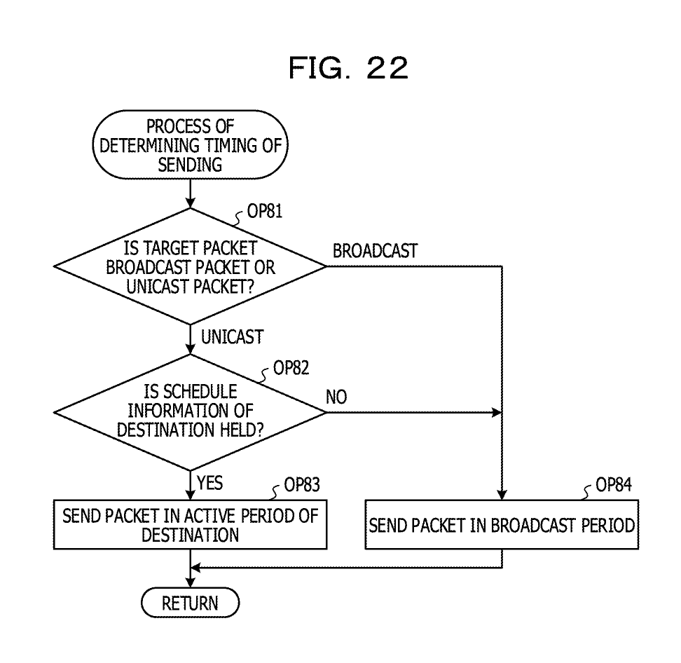

FIG. 22 is an example of a flowchart of the process, to be executed by a sending processing section 25 of each of the nodes 2 according to the second embodiment, of determining the timing of sending. The process illustrated in FIG. 22 corresponds to the process of determining the timing of sending in OP72 illustrated in FIG. 21.

In OP81, the sending processing section 25 determines whether the target packet is a broadcast packet or a unicast packet. The determination of OP81 is made based on a network layer address of a destination of the packet. If the target packet is the broadcast packet (Broadcast in OP81), the process proceeds to OP84. If the target packet is the unicast packet (Unicast in OP81), the process proceeds to OP82.

In OP82, the sending processing section 25 determines whether or not schedule information of a transmission or transfer destination to which the packet is sent or transferred is held in the adjacent node information table. If the schedule information of the transmission or transfer destination is held in the adjacent node information table (YES in OP82), the process proceeds to OP83. If the schedule information of the transmission or transfer destination is not held in the adjacent node information table (NO in OP82), the process proceeds to OP84.

In OP83, the sending processing section 25 determines that the target packet is to be sent or transferred to the transmission or transfer destination in an active period of the transmission or transfer destination. Specifically, the sending processing section 25 determines that a requirement for sending the target packet indicates that the transmission or transfer destination is in the active period of the destination. After that, the process illustrated in FIG. 22 is terminated and the process illustrated in FIG. 21 proceeds to the process of OP73 illustrated in FIG. 21.

In OP84, the sending processing section 25 determines that the target packet is to be sent in a broadcast period. Specifically, the sending processing section 25 determines that the requirement for sending the target packet indicates that the target node 2 is in the broadcast period. After that, the process illustrated in FIG. 22 is terminated and the process illustrated in FIG. 21 proceeds to the process of OP73 illustrated in FIG. 21.

### Effects of Second Embodiment

In the second embodiment, the nodes 2 also autonomously determine active time lengths Ta based on traffic amounts. In an ad-hoc network, the traffic amounts of the nodes 2 are different for the nodes 2 based on the amounts of data to be relayed by the nodes 2. Since the nodes 2 autonomously determine the active time lengths Ta based on the traffic amounts, the active time lengths Ta are different for the nodes 2 and suitable for the traffic amounts of the nodes 2.

For example, a node 2 located at an end point of the sensor network system 100 does not relay data received from another node 2, and traffic from the node 2 located at the end point is the result of the monitoring by the sensor of the node 2. Thus, in the second embodiment, it is likely that an active time length Ta of the node 2 located at the end point is equal to or close to the length of a broadcast period, and the effect of saving power in the node 2 located at the end point is high.

In the second embodiment, each of the nodes 2 and the GW 1 notifies the other devices of schedule information of the target device. Thus, each of the nodes 2 and the GW 1 may determine, upon packet sending, whether or not a destination node 2 to which a packet is to be sent or transferred is in an active period or whether or not the destination node 2 is able to receive the packet.

If the packet to be sent or transferred is the unicast packet and the schedule information of the transmission or transfer destination to which the packet is to be sent or transferred is held in the adjacent node information table (YES in OP82 illustrated in FIG. 22), the sending processing section 25 determines that the requirement for sending indicates that the transmission or transfer destination is in an active period of the destination (in OP83 illustrated in FIG. 22). In this case, in OP73 illustrated in FIG. 21, the sending processing section 25 determines, based on the schedule information of the transmission or transfer destination, whether or not the transmission or transfer destination is in the active period. If the transmission or transfer destination is in the active period, the sending processing section 25 sends the unicast packet via the wireless device 203.

If the packet to be sent or transferred is the unicast packet and the schedule information of the transmission or transfer destination is not held in the adjacent node information table (NO in OP82 illustrated in FIG. 22), the sending processing section 25 determines that the requirement for sending indicates that the target node 2 is in the broadcast period (in OP84 illustrated in FIG. 22). In this case, in OP73 illustrated in FIG. 21, the sending processing section 25 determines whether or not the target node 2 is in the broadcast period. If the target node 2 is in the broadcast period, the sending processing section 25 sends the unicast packet via the wireless device 203.

If the schedule information of the transmission or transfer destination is held in the adjacent node information table of the target node 2, and the destination node 2 to which the unicast packet is to be sent or transferred is in an active period, the unicast packet is sent, regardless of whether the target node 2 is in a broadcast unit or a unicast period. If the schedule information of the transmission or transfer destination is not held in the target node 2, the unicast packet is sent in the broadcast period. In both cases, the transmission or transfer destination node 2 is in an active period. Specifically, since the unicast packet is sent in a state in which the destination node 2 is able to receive the unicast packet, the unicast packet may be reliably sent to the transmission or transfer destination node 2.

If the packet to be sent or transferred is the broadcast packet (Broadcast in OP81 illustrated in FIG. 22), the sending processing section 25 determines that the requirement for sending indicates that the target node 2 is in the broadcast period (in OP84 illustrated in FIG. 22). In this case, in OP73 illustrated in FIG. 21, the sending processing section 25 determines whether or not the target node 2 is currently in the broadcast period. During the broadcast period, all the nodes 2 included in the sensor network system 100 are in active periods. Thus, the broadcast packet may be reliably sent or transferred.

The techniques described in the first and second embodiments are not limited to the sensor network and are applicable to an ad-hoc network.

Storage Medium

A program that causes a computer (hereinafter referred to as computer or the like), another machine, or another device to achieve one or more of the aforementioned functions may be stored in a computer-readable storage medium. The one or more functions may be provided by causing the computer or the like to read the program stored in the storage medium and execute the read program.

The computer-readable storage medium from which the computer or the like is able to read the program is a non-transitory computer-readable storage medium that electrically, magnetically, optically, mechanically, or chemically stores information such as data and the program. Such a non-transitory computer-readable storage medium that is detachable from the computer or the like and from which the computer or the like is able to read the program is, for example, a flexible disk, a magneto-optical disc, a CD-ROM, a CD-R/W, a DVD, a Blu-ray disc, a DAT, a 8-mm tape, a memory card such as a flash memory, or the like. A storage medium that is fixed to the computer or the like and from which the computer or the like is able to read the program is a hard disk, a read only memory (ROM), or the like. In addition, a solid state drive (SSD) may be used as the storage medium detachable from the computer or the like or as the storage medium fixed to the computer or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication apparatus configured to communicate with another wireless communication apparatus in a wireless network in accordance with a synchronized periods, the wireless communication apparatus comprising:
a wireless communication device configured to send and receive a wireless signal with the other wireless communication apparatus;
a memory; and
a processor coupled to the memory and configured to:
acquire an index value related to a traffic amount within the wireless network; and
determine, based on the index value, a first time length of a certain period during which the wireless communication device is in an ON state in a single period of the synchronized periods.

2. The wireless communication apparatus according to claim 1,
wherein if the index value indicates an increase in the traffic amount, the processor increases the first time length, and if the index value indicates a reduction in the traffic amount, the processor reduces the first time length.

3. The wireless communication apparatus according to claim 1,
wherein the processor acquires a second time length based on a time period for receiving and sending the wireless signal of the wireless communication device in the single period and calculates, as the index value, the ratio of the second time length to the first time length in the single period.

4. The wireless communication apparatus according to claim 3,
wherein the processor receives, from the other wireless communication apparatus, information on a time period for sending data held in the other wireless communication apparatus and scheduled to be sent and acquires the second time length based on a time period for receiving and sending the wireless signal of the wireless communication device and the information on the time period for sending the data held in the other wireless communication apparatus and scheduled to be sent.

5. The wireless communication apparatus according to claim 1,
wherein the processor receives relay history record information including information on wireless communication apparatuses that have relayed a packet, and the processor acquires the index value based on the number of the wireless communication apparatuses that have relayed the packet.

6. The wireless communication apparatus according to claim 1,
wherein the processor notifies, via the wireless communication device, the other wireless communication apparatus of schedule information on the certain period that is based on the first time length and during which the wireless communication device is in the ON state in the single period.

7. The wireless communication apparatus according to claim 6,
wherein the processor controls the turning on and off of a wireless communication device of the other wireless communication apparatus based on the schedule information sent by the wireless communication device.

8. The wireless communication apparatus according to claim 6,
wherein the processor controls the turning on and off of the wireless communication device in accordance with the schedule information on the certain period that is based on the determined first time length and during which the wireless communication device is in the ON state in the single period.

9. The wireless communication apparatus according to claim 8,
wherein the single period includes a first period that is common to the other wireless communication apparatus and in which the wireless communication device is in the ON state, and
wherein the processor determines the first time length so that the first time length is equal to or longer than the length of the first period.

10. The wireless communication apparatus according to claim 9,
wherein the processor determines whether or not a packet to be sent to a broadcast address has been sent in the first period.

11. The wireless communication apparatus according to claim 9,
wherein the processor is further configured to:
receive schedule information of the other wireless communication apparatus from the other wireless communication apparatus;
send a packet in a period during which a wireless communication device of a destination wireless communication apparatus that is a destination of the packet is in an ON state if the packet to be sent to a unicast address includes schedule information of the destination wireless communication apparatus; and
send the packet in the first period if the packet does not include the schedule information of the destination wireless communication apparatus.

12. A wireless communication system in a wireless network comprising:
a wireless communication apparatus having:
a wireless communication device configured to send and receive a wireless signal with the other wireless communication apparatus;
a first memory; and
a first processor coupled to the first memory and configured to control ON and OFF states of the wireless communication device in accordance with a schedule information of a certain period during which the wireless communication device is in an ON state in a single period of a synchronized periods; and
a control apparatus configured to communicate with the wireless communication apparatus in accordance with a synchronized periods, having:
a second memory; and
a second processor coupled to the second memory and configured to:
acquire an index value related to a traffic amount within the wireless network;
determine, based on the index value, a first time length of the certain period during which the wireless communication device is in the ON state in the single period of the synchronized periods; and
notice the schedule information on the basis of the determined single period.

13. A communication control method for a wireless communication apparatus configured to communicate with another wireless communication apparatus in a wireless network in accordance with a synchronized periods, the communication control method comprising:
sending and receiving, by a wireless communication device, a wireless signal with the other wireless communication apparatus;
acquiring, by a processor, an index value related to a traffic amount within the wireless network; and
determining, by a processor, a first time length of a certain period during which the wireless communication device is in an ON state in a single period of the synchronized periods based on the index value.
